(19) United States
(12) Patent Application Publication
(10) Pub. No.: US 2022/0248256 A1
(43) Pub. Date: Aug. 4, 2022

(54) TECHNIQUES FOR RADIO ACCESS TECHNOLOGY DEPRIORITIZATION

(71) Applicant: QUALCOMM Incorporated, San Diego, CA (US)

(72) Inventors: Kuo-Chun LEE, San Diego, CA (US); Brian Clarke BANISTER, San Diego, CA (US); Arvind Vardarajan SANTHANAM, San Diego, CA (US); Reza SHAHIDI, San Diego, CA (US); Bhupesh Manoharlal UMATT, Poway, CA (US); Daniel AMERGA, San Diego, CA (US); Zhang ZHOU, San Diego, CA (US); Qin Xue FRANTTI, San Diego, CA (US); Xuepan GUAN, San Diego, CA (US); Tom CHIN, San Diego, CA (US)

(21) Appl. No.: 17/454,639

(22) Filed: Nov. 12, 2021

Related U.S. Application Data
(60) Provisional application No. 63/144,705, filed on Feb. 2, 2021.

(51) Int. Cl. H04W 28/02; H04W 28/08; H04W 72/10

(52) U.S. Cl. CPC H04W 28/0268; H04W 72/10; H04W 28/0819

(57) ABSTRACT

Various aspects of the present disclosure generally relate to wireless communication. In some aspects, a user equipment (UE) may establish, in a communication mode, a communication connection with a first radio access technology (RAT) or a second RAT. The UE may receive or identify an indication to deprioritize the first RAT. The UE may perform, based at least in part on the indication to deprioritize the first RAT, an action to deprioritize the first RAT, where the action is based at least in part in the communication mode. Numerous other aspects are described.

### CROSS-REFERENCE TO RELATED APPLICATION

This patent application claims priority to U.S. Provisional Patent Application No. 63/144,705, filed on Feb. 2, 2021, entitled “TECHNIQUES FOR NEW RADIO (NR) RADIO ACCESS TECHNOLOGY DEPRIORITIZATION,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for radio access technology (RAT) deprioritization.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or forward link) refers to the communication link from the BS to the UE, and “uplink” (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes establishing, in a communication mode, a communication connection with a first radio access technology (RAT) or a second RAT; receiving or identifying, by a modem of the UE, an indication to deprioritize the first RAT; and performing, based at least in part on the indication to deprioritize the first RAT, an action to deprioritize the first RAT, wherein the action is based at least in part in the communication mode.

In some aspects, a UE for wireless communication includes a memory and one or more processors coupled to the memory. The one or more processors may be configured to: establish, in a communication mode, a communication connection with a first RAT or a second RAT; receive or identify an indication to deprioritize the first RAT; and perform, based at least in part on the indication to deprioritize the first RAT, an action to deprioritize the first RAT, wherein the action is based at least in part in the communication mode.

In some aspects, a non-transitory computer-readable medium storing a set of instructions for wireless communication includes one or more instructions that, when executed by one or more processors of a UE, cause the UE to: establish, in a communication mode, a communication connection with a first RAT or a second RAT; receive or identify an indication to deprioritize the first RAT; and perform, based at least in part on the indication to deprioritize the first RAT, an action to deprioritize the first RAT, wherein the action is based at least in part in the communication mode.

In some aspects, an apparatus for wireless communication includes means for establishing, in a communication mode, a communication connection with a first RAT or a second RAT; means for receiving or identifying an indication to deprioritize the first RAT; and means for performing, based at least in part on the indication to deprioritize the first RAT, an action to deprioritize the first RAT, wherein the action is based at least in part in the communication mode.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 illustrates an example of a wireless network in which a UE may support additional communication modes, in accordance with the present disclosure.

FIGS. 4-7 are diagrams illustrating examples associated with radio access technology (RAT) deprioritization, in accordance with the present disclosure.

FIG. 8 is a diagram illustrating an example process associated with RAT deprioritization, in accordance with the present disclosure.

FIG. 9 is a block diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

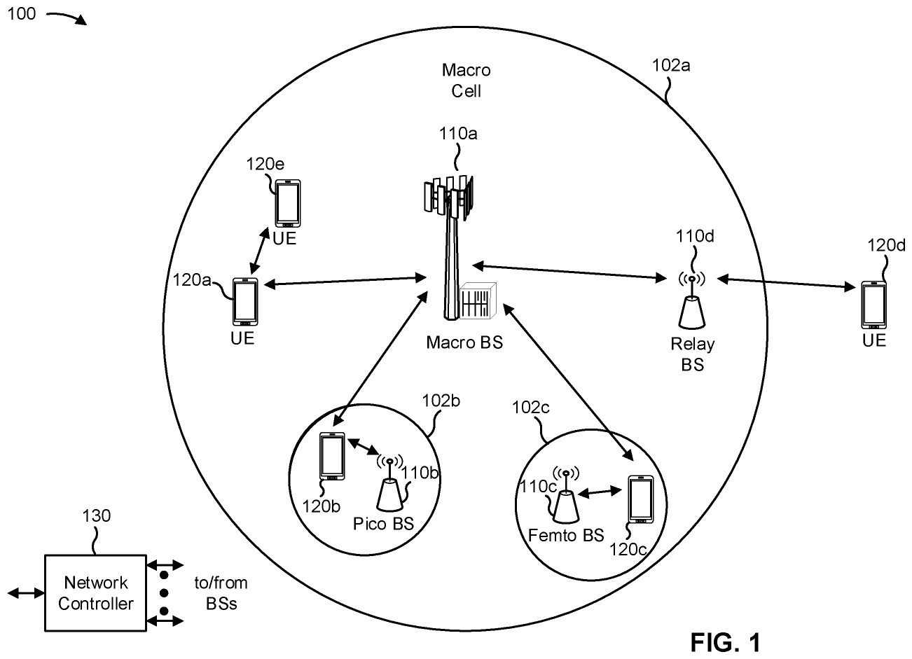

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. ABS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

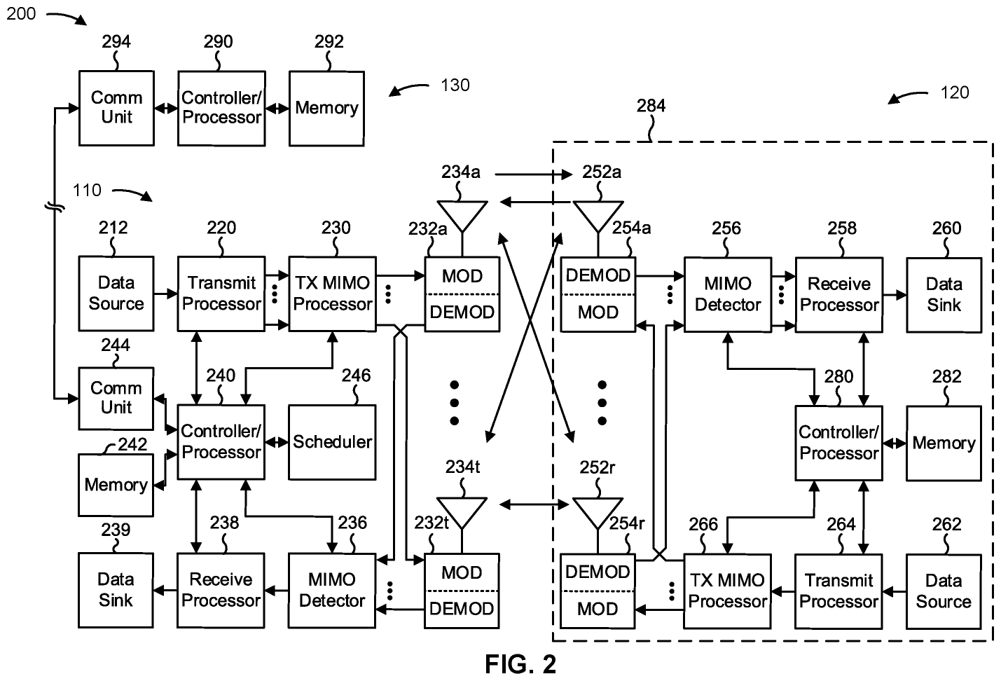

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, an/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein.

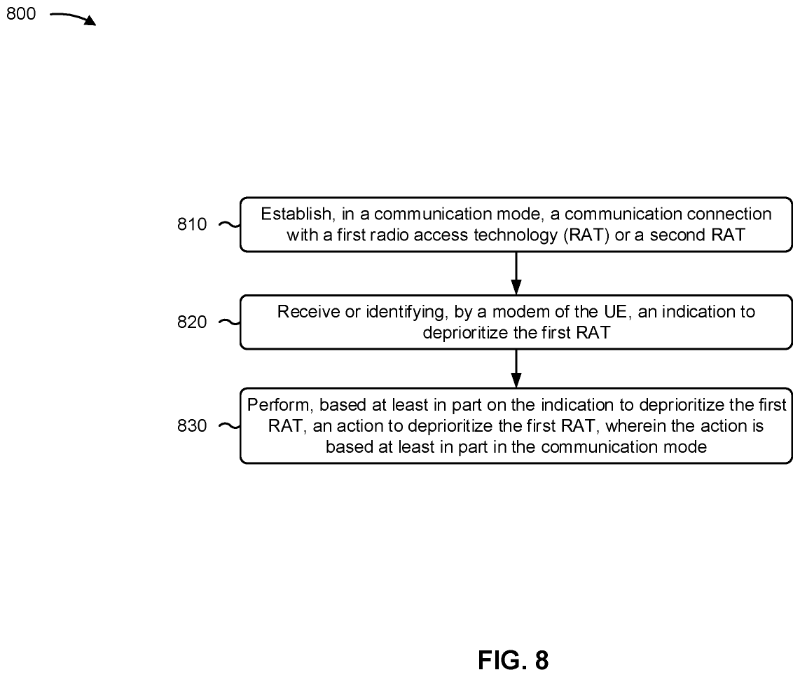

Controller/processor 240 of base station 110, controller/processor 280 of UE 120, and/or any other component(s) of FIG. 2 may perform one or more techniques associated with RAT deprioritization, as described in more detail elsewhere herein. For example, controller/processor 240 of base station 110, controller/processor 280 of UE 120, and/or any other component(s) of FIG. 2 may perform or direct operations of, for example, process 800 of FIG. 8, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, and/or other processes as described herein. In some aspects, executing instructions may include running the instructions, converting the instructions, compiling the instructions, and/or interpreting the instructions.

In some aspects, the UE 120 includes means for establishing, in a communication mode, a communication connection with a first RAT or a second RAT; means for receiving or identifying, by a modem of the UE, an indication to deprioritize the first RAT; and/or means for performing, based at least in part on the indication to deprioritize the first RAT, an action to deprioritize the first RAT, wherein the action is based at least in part in the communication mode. The means for the UE 120 to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, the UE 120 includes means for establishing a first communication connection with the first RAT; means for terminating the first communication connection with the first RAT; and/or means for establishing a second communication connection with the second RAT. In some aspects, the UE 120 includes means for establishing a first communication connection with the second RAT; means for maintaining the first communication connection with the second RAT; and/or means for refraining from establishing a second communication connection with the first RAT.

In some aspects, the UE 120 includes means for transmitting, by the modem of the UE and to a first RAT protocol stack of the UE, an indication to deprioritize the first RAT; and/or means for transmitting, by the modem of the UE and to a second RAT protocol stack of the UE, an indication to deprioritize the first RAT.

In some aspects, the UE 120 includes means for receiving, by the modem and from an application programming interface (API), the indication to deprioritize the first RAT. In some aspects, the UE 120 includes means for identifying, by the modem, a trigger to deprioritize the first RAT.

In some aspects, the UE 120 includes means for establishing, in a connected communication mode, a communication connection with the first RAT. In some aspects, the UE 120 includes means for performing a local release of the communication connection with the first RAT. In some aspects, the UE 120 includes means for performing an operation to autonomously release the communication connection with a redirection to the second RAT.

In some aspects, the UE 120 includes means for transmitting, from a first RAT protocol stack of the UE and to a second RAT protocol stack of the UE, a redirection command indicating one or more second RAT operating frequencies. In some aspects, the UE 120 includes means for identifying the one or more second RAT operating frequencies from a second RAT measurement object or a system information block of the first RAT protocol stack.

In some aspects, the UE 120 includes means for transmitting, from the first RAT protocol stack of the UE and to the second RAT protocol stack of the UE, the redirection command indicating the one or more second RAT operating frequencies in a prioritized order. In some aspects, the UE 120 includes means for ordering, in the redirection command, second RAT operating frequencies identified from a measurement object before second RAT operating frequencies identified from a system information block of the first RAT protocol stack. In some aspects, the UE 120 includes means for ordering, in the redirection command, one or more second RAT operating frequencies identified from a measurement object based at least in part on at least one of: an amount of time since each of the one or more second RAT operating frequencies have been measured by the UE, a measurement value associated with each of the one or more second RAT operating frequencies, or whether the UE detected each of the one or more second RAT operating frequencies when measuring the one or more second RAT operating frequencies.

In some aspects, the UE 120 includes means for initiating a first timer upon transmitting the redirection command; and/or means for refraining from performing another operation to release the communication connection with a redirection to the LTE RAT until after the first timer expires. In some aspects, the UE 120 includes means for initiating a second timer upon transmitting the redirection command; and/or means for establishing, if the UE has not established a communication connection with the second RAT prior to an expiration of the second timer, another communication connection with the first RAT.

In some aspects, the UE 120 includes means for determining whether a voice over NR capability is supported by the UE and a serving cell associated with the communication connection with the first RAT. In some aspects, the UE 120 includes means for performing an operation to release the communication connection with a redirection to the second RAT if at least one of the UE or the serving cell does not support the voice over NR capability. In some aspects, the UE 120 includes means for refraining from performing an operation to release the communication connection with a redirection to the second RAT if both the UE and the serving cell support the voice over NR capability.

In some aspects, the UE 120 includes means for determining whether the serving cell associated with the communication connection with the first RAT supports the voice over NR capability based at least in part on at least one of: a previous interaction with the serving cell, or an interaction of another UE with the serving cell.

In some aspects, the UE 120 includes means for determining that the serving cell associated with the communication connection with the first RAT does not support the voice over NR capability based at least in part on at least one of: receiving, from the serving cell, an indication to fallback to the second RAT in response to a request to establish a voice call, and/or receiving, from the serving cell, an indication that the voice over NR capability is not supported by the serving cell. In some aspects, the UE 120 includes means for determining whether the voice over NR capability is supported by the UE and the serving cell based at least in part on at least one of: an indication included in the indication to deprioritize the first RAT, or a configuration of the UE.

In some aspects, the UE 120 includes means for establishing, in an idle communication mode or an inactive communication mode, a communication connection with the first RAT. In some aspects, the UE 120 includes means for modifying, in a first RAT protocol stack of the UE, one or more cell reselection criteria parameters associated with the first RAT; and/or means for modifying, in the first RAT protocol stack of the UE, one or more cell reselection criteria parameters associated with the second RAT.

In some aspects, the UE 120 includes means for refraining from entering a sleep mode associated with the idle communication mode or the inactive communication mode; means for performing a continuous search for and measurement of second RAT operating frequencies; and/or means for suspending a search for and measurement of first RAT operating frequencies. In some aspects, the UE 120 includes means for initiating a panic search timer; means for performing a panic search procedure to search for second RAT operating frequencies; and/or means for terminating the panic search procedure after an expiration of the panic search timer.

In some aspects, the UE 120 includes means for establishing, in a connected communication mode, a communication connection with the second RAT. In some aspects, the UE 120 includes means for refraining from transmitting, to a serving cell associated with the communication connection, a measurement report associated with first RAT operating frequencies.

In some aspects, the UE 120 includes means for receiving, from a serving cell associated with the communication connection, a handover command indicating that the UE is to perform a handover procedure to a first RAT operating frequency, means for reestablishing, based at least in part on the indication to deprioritize the first RAT, the communication connection with the second RAT.

In some aspects, the UE 120 includes means for receiving, from a serving cell associated with the communication connection, a release with redirection command indicating that the UE is to redirect to a first RAT frequency, means for releasing the communication connection; and/or means for establishing, in an idle communication mode, another communication connection with the second RAT.

In some aspects, the UE 120 includes means for establishing, in an idle communication mode, a communication connection with the second RAT. In some aspects, the UE 120 includes means for modifying, in a second RAT protocol stack of the UE, one or more cell reselection criteria parameters associated with the first RAT; and/or means for modifying, in the second RAT protocol stack of the UE, one or more cell reselection criteria parameters associated with the second RAT.

As indicated above, FIG. 2 is provided as an example. Other examples may differ from what is described with regard to FIG. 2.

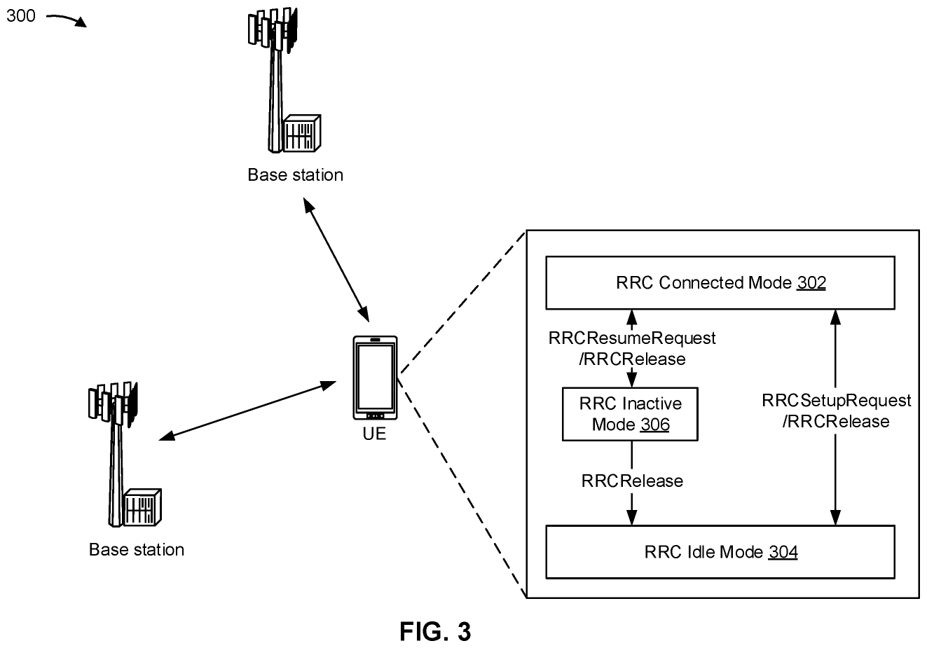

FIG. 3 illustrates an example 300 of a wireless network (e.g., wireless network 100) in which a UE (e.g., UE 120) may support additional communication modes, in accordance with the present disclosure. The UE may be communicatively connected with one or more base stations in the wireless network. For example, the UE may be connected to the one or more base stations in a dual connectivity configuration. In this case, a first base station may serve the UE as a control node or a primary node and a second base station may serve the UE as a secondary node.

As illustrated in FIG. 3, the UE may support a connected communication mode (e.g., a radio resource control (RRC) connected mode 302), an idle communication mode (e.g., an RRC idle mode 304), and an inactive communication mode (e.g., an RRC inactive mode 306). RRC inactive mode 306 may functionally reside between RRC connected mode 302 and RRC idle mode 304. The RRC connected mode 302 may be referred to herein as an RRC active mode. The RRC modes (e.g., RRC connected mode 302, RRC idle mode 304, and/or RRC inactive mode 306) may be referred to as RRC states.

In the RRC connected mode 302, the UE may establish a communication connection with a base station (e.g., a radio access network (RAN) connection that includes a control plane connection and a user plane connection) for communicating data between the UE and the base station. That is, in the RRC connected mode 302 the UE and the base station may be enabled to transfer unicast data to and/or from the UE. Moreover, the UE may be enabled to perform network controlled mobility operations, such as performing measurements and/or transmitting measurement reports. In the RRC idle mode 304, the UE may be enabled to monitor for paging communications from a base station. The UE may transition to the RRC connected mode 302 based on receiving a page from the base station while in the RRC idle mode 304 (or the RRC inactive mode 306). In some cases, in the RRC idle mode 304, the UE may be configured with a discontinuous reception (DRX) cycle for monitoring for pages from the base station. Therefore, the UE may be enabled to enter a sleep state (e.g., in which the UE is not monitoring for communications) while in the RRC idle mode 304 to conserve power resources. The UE may be enabled to perform cell reselection operations while in the RRC idle mode 304 (or the RRC inactive mode 306). Similarly, in the RRC inactive mode 306, the UE may be enabled to monitor for paging communications from a base station and/or may be configured with a DRX cycle.

The UE may transition between different modes based at least in part on various commands and/or communications received from the one or more base stations. For example, the UE may transition from RRC connected mode 302 or RRC inactive mode 306 to RRC idle mode 304 based at least in part on receiving an RRCRelease communication. As another example, the UE may transition from RRC connected mode 302 to RRC inactive mode 306 based at least in part on receiving an RRCRelease with suspendConfig communication. As another example, the UE may transition from RRC idle mode 304 to RRC connected mode 302 based at least in part on receiving an RRCSetupRequest communication. As another example, the UE may transition from RRC inactive mode 306 to RRC connected mode 302 based at least in part on receiving an RRCResumeRequest communication. As described above, the UE may transition to the RRC connected mode 302 to enable data to be transferred between the UE and a base station. The UE may transition from the RRC connected mode 302 to the RRC idle mode 304 or the RRC inactive mode 306 to save power resources (e.g., when there is no data to be transferred).

When transitioning to RRC inactive mode 306, the UE and/or the one or more base stations may store a UE context (e.g., an access stratum (AS) context and/or higher-layer configurations). This permits the UE and/or the one or more base stations to apply the stored UE context when the UE transitions from RRC inactive mode 306 to RRC connected mode 302 in order to resume communications with the one or more base stations, which reduces latency of transitioning to RRC connected mode 302 relative to transitioning to the RRC connected mode 302 from RRC idle mode 304.

In some cases, the UE may communicatively connect with a new control node or a new primary node when transitioning from RRC idle mode 304 or RRC inactive mode 306 to RRC connected mode 302 (e.g., a control node or a primary node that is different from the last serving control node or a primary node when the UE transitioned to RRC idle mode 304 or RRC inactive mode 306). In this case, the new control node or a primary node may be responsible for identifying a secondary node for the UE in the dual connectivity configuration.

As indicated above, FIG. 3 is provided as an example. Other examples may differ from what is described with regard to FIG. 3.

A UE may be capable of communicating using both an NR RAT and an LTE RAT. In some cases, it may be desirable for the UE to communicate using the LTE RAT rather than the NR RAT. For example, communicating using the NR RAT may consume more resources of the UE, such as battery resources or processing resources, among other examples. Additionally, or alternatively, an NR communication link may be poor or unstable. Additionally, or alternatively, the UE and/or a serving cell (e.g., a serving base station) of the NR RAT may not support one or more capabilities required for the UE. For example, the UE and/or the NR RAT serving cell may not support a voice call capability for the NR RAT (e.g., a voice over NR (VoNR) capability). As a result, if the UE requires a voice call capability (e.g., to make a voice call), then the UE may be unable to use the NR RAT. Therefore, in some situations, it may be beneficial for the UE to deprioritize communicating using the NR RAT.

In some cases, the UE may deprioritize communicating using the NR RAT by disabling an N1 mode of the UE 120 (e.g., a 5G/NR standalone mode of the UE). For example, the UE may remove all NR frequency bands from a set of frequency bands that the UE is capable of using for communicating with a wireless network. However, disabling the mode requires the UE to signal an update to the wireless network (e.g., to one or more base stations) indicating updated capability information of the UE (e.g., indicating that the UE is not capable of communicating using the NR RAT). The indication of the updated capability information of the UE adds additional signaling overhead for deprioritizing communicating using the NR RAT. Further, there is added latency before the NR RAT is deprioritized associated with the signaling for the updated capability information of the UE (e.g., there is an added delay associated with the signaling before the NR RAT deprioritization can take effect). Moreover, by disabling the N1 mode, the UE cannot communicate using the NR RAT under any circumstances. For example, if a communication link with the LTE RAT becomes poor or unstable, the UE may be required to use a RAT (such as a 2G RAT or a 3G RAT) that is associated with lower performance (e.g., lower data rates or lower throughput, among other examples) than the LTE RAT and the NR RAT.

Some techniques and apparatuses described herein enable NR RAT deprioritization. For example, a modem of a UE may receive an indication to deprioritize the NR RAT (e.g., over an LTE RAT). In some aspects, the modem of the UE may determine or identify that the NR RAT is to be deprioritized based at least in part on detecting a trigger event (e.g., without receiving an external command or indication to deprioritize the NR RAT). The UE (e.g., the modem of the UE) may perform one or more actions to deprioritize the NR RAT (and/or prioritize the LTE RAT). The one or more actions may be based at least in part on a communication mode (e.g., an RRC communication mode) and/or a RAT to which the UE is connected. As described above in connection with FIG. 3, the UE may perform different operations and/or may have different capabilities in different RRC communication modes. For example, the UE may perform different actions to deprioritize the NR RAT in an RRC connected mode versus an RRC idle mode or an RRC inactive mode. Similarly, the UE may perform different actions to deprioritize the NR RAT if the UE is connected to an NR cell versus if the UE is connected to an LTE cell. Additionally, the indication to deprioritize the NR RAT may be a continuous indication (e.g., may be a flag that indicates the NR RAT is to be deprioritized until the flag is changed). Therefore, if the UE transitions to a different RRC connected mode and/or establishes a connection with a different RAT, the UE may perform one or more different or additional actions to deprioritize the NR RAT.

As a result, a signaling overhead associated with deprioritizing the NR RAT is reduced (e.g., eliminated) as the UE is not required to update capability information of the UE to a base station when deprioritizing the NR RAT. Moreover, by deprioritizing the NR RAT as described above, the UE deprioritizes the NR RAT, but does not eliminate the possibility of switching to the NR RAT. As a result, if an LTE communication link becomes poor or unstable (or fails) while the NR RAT is deprioritized, the UE may still reselect to an NR cell, rather than being required to reselect to a 2G cell or a 3G cell. Communicating using the NR cell rather a 2G cell or a 3G cell when an LTE communication link becomes poor or unstable (or fails) improves a communication performance of the UE. Moreover, the UE may perform different actions based at least in part on the RRC communication mode and/or the RAT that the UE is currently using to communicate. Therefore, the UE may be enabled to maintain a deprioritization of the NR RAT if the UE transitions to a different RRC communication mode and/or establishes a communication connection with a different RAT. By deprioritizing the NR RAT as described above, the UE may ensure that capabilities required by the UE, such as a voice capability, are available to the UE. Moreover, the UE may conserve battery and/or power resources that would have otherwise been consumed using the NR RAT (e.g., rather than the LTE RAT).

For example, if the UE is in an RRC connected mode with an NR cell, then the UE may perform a local release with redirection to one or more LTE operating frequencies. For example, an NR protocol stack of the UE may initiate a local release (e.g., autonomously, without receiving an RRC release command from the NR cell). The NR protocol stack of the UE may transmit, to an LTE protocol stack of the UE, a redirection command indicating one or more LTE operating frequencies. The LTE protocol stack may attempt to establish a communication connection with an LTE serving cell using the one or more LTE operating frequencies. If the UE is unable to establish a connection with an LTE serving cell (e.g., within an amount of time), then the UE may reestablish a connection with an NR serving cell.

If the UE is in an RRC idle mode or an RRC inactive mode with an NR cell, then the UE may deprioritize the NR RAT by modifying one or more cell reselection criteria parameters associated with the NR RAT and/or the LTE RAT (e.g., for reselecting from the NR RAT to the LTE RAT and/or for reselecting from the LTE RAT to the NR RAT). In some aspects, the UE may perform a panic search to identify an LTE operating frequency (e.g., may refrain from entering a sleep mode, may suspend searches for NR and measurement of operating frequencies, and/or may continuously search for and measure LTE operating frequencies). The NR protocol stack of the UE may transmit, to the LTE protocol stack of the UE, a reselection command that indicates the LTE operating frequency. The LTE protocol stack may establish a communication connection with an LTE serving cell using the LTE operating frequency.

If the UE is in an RRC connected mode with an LTE cell, then the UE may deprioritize the NR RAT by suspending the transmission of NR measurement reports (e.g., measurement reports that indicate a measurement associated with an NR operating frequency) to the LTE cell. If the UE receives a handover command indicating that the UE is to establish a communication connection with an NR cell, then the UE may reject or ignore the handover command and perform an operation to reestablish the communication connection with the LTE cell. If the UE receives a redirection command to an NR operating frequency, then the UE may reject or ignore the redirection command and may remain in the LTE cell in an RRC idle mode.

If the UE is in an RRC idle mode with an LTE cell, then the UE may deprioritize the NR RAT by modifying one or more cell reselection criteria parameters associated with the NR RAT and/or the LTE RAT (e.g., for reselecting from the NR RAT to the LTE RAT and/or for reselecting from the LTE RAT to the NR RAT). For example, the UE may modify the one or more cell reselection criteria parameters in the LTE protocol stack of the UE.

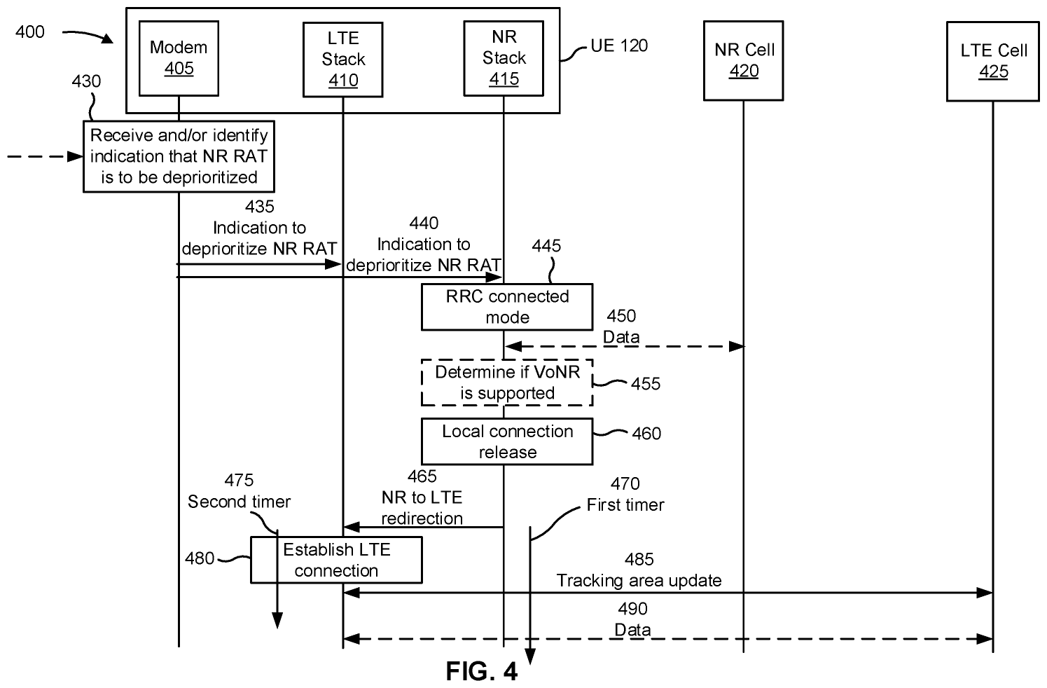

FIG. 4 is a diagram illustrating an example 400 associated with RAT deprioritization, in accordance with the present disclosure. FIG. 4 shows a signaling diagram for a UE 120 in communication with an NR cell 420 (e.g., with a base station 110 associated with the NR cell 420) using a modem 405. In some aspects, the modem 405 includes one or more processors that may operate based at least in part on instructions stored in a memory. In some aspects, the modem 405 may receive instructions from a modem control interface, an API, and/or one or more applications. In some aspects, the UE 120 may execute the modem control interface, the API, and/or the one or more applications on hardware that is at least partially separate from the modem 405. Additionally, or alternatively, the UE 120 may execute the modem control interface, the API, and/or the one or more applications on hardware that is at least partially integrated with the modem 405. The NR RAT may be referred to herein as a 5G RAT. The LTE RAT may be referred to herein as a 4G RAT.

Although examples described herein are described in connection with the NR RAT and the LTE RAT, the operations and techniques described herein (e.g., in connection with FIGS. 4-9) may be similarly applied to any RATs. In other words, in examples described herein, the NR RAT may be a first RAT and the LTE RAT may be a second RAT. In other examples, the first RAT may be a RAT subsequent to the NR RAT (e.g., a 6G RAT) and the second RAT may be the NR RAT. In other examples, the first RAT may be the NR RAT and the second RAT may be any other RAT (e.g., LTE, 3G, 2G, 6G, or another RAT). The examples described herein may be similarly used to deprioritize any RAT (e.g., and prioritize another RAT or other RATs).

The modem control interface may be an API. The API may receive information from the one or more applications associated with or stored by the UE. The API may transmit instructions to the modem 405 that are based at least in part on the information received from the one or more applications. In some aspects, the modem 405 may include a modem manager component that is configured to transmit instructions to an LTE protocol stack 410 and an NR protocol stack 415.

As shown in FIG. 4, the UE 120 may include the LTE protocol stack 410 and the NR protocol stack 415. In some aspects, the LTE protocol stack 410 and the NR protocol stack 415 may be associated with different hardware components of the UE 120 (e.g., for communicating using the NR RAT and the LTE RAT, respectively). In some aspects, the LTE protocol stack 410 and the NR protocol stack 415 may be associated with one or more common hardware components, such as the modem 405 among other examples.

The LTE protocol stack 410 and the NR protocol stack 415 may be implemented on the UE 120 to enable the UE 120 to communicate with a base station 110 using the LTE RAT and the NR RAT, respectively. The LTE protocol stack 410 and/or the NR protocol stack 415 may include a non-access stratum (NAS) layer, an RRC layer, a packet data convergence protocol (PDCP) layer, and/or a physical (PHY) layer, among other examples. An LTE protocol stack implemented on a base station 110 of an LTE cell 425 may include corresponding layers to the LTE protocol stack 410. Similarly, an NR protocol stack implemented on a base station 110 of the NR cell 420 may include corresponding layers to the NR protocol stack 415. In some aspects, the NAS layer and/or the RRC layer may be referred to as a “layer 3,” the PDCP layer may be referred to as a “layer 2,” and the PHY layer may be referred to as a “layer 1.”

In some aspects, a PDCP layer may include one or more sub-layers. For example, the PDCP layer may include a radio link control (RLC) sub-layer or a medium access control (MAC) sub-layer, among other examples. In some aspects, the LTE protocol stack 410 and/or the NR protocol stack 415 may include an adaptation sub-layer (e.g., a service data adaptation protocol (SDAP) sub-layer).

As shown by reference number 430, the UE 120 may determine that the NR RAT should be deprioritized. For example, the UE 120 (e.g., the modem 405) may determine that the NR RAT should be deprioritized based at least in part on detecting or identifying a trigger (e.g., a trigger event). For example, the trigger may include determining that a temperature of the UE 120 is above a temperature threshold (e.g., indicating that UE 120 is overheating), determining that a battery level of the UE 120 is below a charge threshold (e.g., indicating that UE 120 has a low battery level), determining that a connection with the NR RAT is unstable or poor (e.g., determining that a parameter, such as RSRP or RSRQ, of the NR RAT connection is below a threshold), among other examples. In some aspects, the UE 120 (e.g., the modem 405) may determine that the NR RAT should be deprioritized based at least in part on detecting that a voice call has been initiated. For example, the UE 120 may detect that a voice call has been initiated using a WiFi connection and/or using an LTE connection. As some UEs 120 and/or some NR cells do not support voice calls using the NR RAT (e.g., do not support VoNR), the UE 120 may determine that the NR RAT should be deprioritized to ensure that the UE 120 does not establish (or deprioritizes establishing) a communication connection using the NR RAT while the voice call is ongoing (e.g., to avoid the voice call being dropped or the voice call failing due to VoNR being unsupported).

As shown in FIG. 4, in some aspects, a modem control interface (e.g., an API) and/or one or more applications may transmit, to the modem 405, an indication to deprioritize the NR RAT (e.g., shown by the dashed arrow in FIG. 4). The modem control interface and/or the one or more applications may determine that the NR RAT should be deprioritized in a similar manner as described above. In some aspects, where the modem 405 determines that the NR RAT should be deprioritized (e.g., as described above), the modem 405 may not receive the indication from the modem control interface and/or the one or more applications.

In some aspects, the indication to deprioritize the NR RAT may be a flag (e.g., a Boolean flag). The flag may be a single bit flag that may be set to true (e.g., a value of 1) when the NR RAT is to be deprioritized and may be set to false (e.g., a value of 0) when the NR RAT is not to be deprioritized. The flag may be a persistent flag such that the indication to deprioritize the NR RAT may persist or remain until the flag is set to false (e.g., until the indication to deprioritize the NR RAT is canceled or removed).

As shown by reference number 435, based at least in part on receiving or identifying the indication to deprioritize the NR RAT, the modem 405 may transmit, to the LTE protocol stack 410, an indication to deprioritize the NR RAT (e.g., may set a flag associated with the LTE protocol stack 410 to true or a value of 1). Similarly, as shown by reference number 440, based at least in part on receiving or identifying the indication to deprioritize the NR RAT, the modem 405 may transmit, to the NR protocol stack 415, an indication to deprioritize the NR RAT (e.g., may set a flag associated with the NR protocol stack 415 to true or a value of 1).

As shown by reference number 445, in example 400, the UE 120 may establish a communication connection with the NR cell 420 in an RRC connected mode. For example, the UE 120 may be in the RRC connected mode with the NR cell 420 when receiving or identifying the indication to deprioritize the NR RAT. In some aspects, the UE 120 may be in the RRC connected mode with the NR cell 420 while a flag associated with deprioritizing the NR is set to true or a value of 1. For example, the UE 120 may receive or identify the indication to deprioritize the NR RAT and may transition to the RRC connected mode and/or may establish the communication connection with the NR cell 420 before the indication to deprioritize the NR RAT is canceled (e.g., before a flag associated with deprioritizing the NR is set to false or a value of 0). As shown by reference number 450, in some aspects, the UE 120 and the NR cell 420 may communicate data between the UE 120 and the NR cell 420 while in the RRC connected mode.

As shown by reference number 455, in some aspects, the UE 120 may determine whether the UE 120 and/or the NR cell 420 supports voice calls using the NR RAT. For example, the UE 120 may determine if the UE 120 and/or the NR cell 420 support a VoNR capability. If VoNR is not support by the UE 120 or the NR cell 420, then the UE 120 may continue to deprioritize the NR RAT (e.g., as described in more detail below). If VoNR is supported by both the UE 120 and the NR cell 420, then the UE 120 may terminate the deprioritization of the NR RAT (e.g., may not proceed with performing one or more (or all) of the operations described below).

As indicated by the dashed lines in FIG. 4, determining whether the UE 120 and/or the NR cell 420 support a VoNR capability may be optional. For example, the UE 120 may determine if VoNR is supported based at least in part on a trigger for deprioritizing the NR RAT being the initiation of a voice call using the UE 120 (e.g., using a WiFi communication connection). For example, if the modem 405 and/or the modem control interface (or application of the UE) determine that the NR RAT should be deprioritized based at least in part on a voice call being initiated, then the UE 120 may determine if VoNR is supported as described herein. In some aspects, when transmitting the indication to deprioritize the NR RAT to the NR protocol stack 415, the modem 405 may transmit an indication of whether the NR protocol stack 415 is to determine if VoNR is supported. In some aspects, an indication received by the modem 405 (e.g., from a modem control interface and/or an application) may include an indication (e.g., a flag) of whether the UE 120 is to determine if VoNR is supported. In some aspects, such as when the modem 405 determines that the NR RAT should be prioritized (e.g., without receiving an external indication), the UE 120 may indicate that the UE 120 is to determine if VoNR is supported in a configuration of the UE 120 (e.g., in a non-volatile (NV) configuration).

The UE 120 may determine if VoNR is supported by the UE 120 based at least in part on capability information stored by the UE 120. For example, the capability information may indicate whether the UE 120 supports VoNR.

The UE 120 may determine if VoNR is supported by the NR cell 420 based at least in part on a previous interaction with the NR cell 420 and/or based at least in part on a previous interaction of another UE 120 with the NR cell 420. In some aspects, the UE 120 may determine if VoNR is supported by the NR cell 420 based at least in part on historical information associated with the NR cell 420. For example, the NR cell 420 may not be capable of supporting VoNR, and thus may trigger fallback to LTE to attempt to set up a request voice call using voice over LTE (VoLTE). A fallback from NR to LTE may be referred to as an evolved packet system (EPS) fallback (FB). The NR cell 420 may transmit a fallback command (e.g., an EPS FB command) to the UE 120 using the NR RAT when the UE 120 requests to establish a voice call with the NR cell 420. As a result, the UE 120 may determine that the NR cell 420 does not support VoNR and may store an indication (e.g., in a database) indicating that the NR cell 420 does not support VoNR. In some aspects, the UE 120 may determine that the NR cell 420 does not support VoNR based at least in part on receiving, from the NR cell 420, an indication that the NR cell 420 does not support VoNR. For example, the NR cell 420 may indicate that VoNR is not supported by the NR cell in a voiceFallbackIndication information element (IE) of an RRC message (e.g., in an RRCRelease message or a MobilityFromNRCommand message).

In some aspects, the UE 120 may store a database that includes information indicating whether one or more NR cells are associated with fallback from the NR RAT to the LTE RAT for voice calls (e.g., whether the one or more NR cells are associated with EPS FB to LTE), which is sometimes referred to herein as “EPS fallback.” In other words, the database may indicate whether VoNR is supported by one or more NR cells. The UE 120 may search the database to determine whether the NR cell 420 supports VoNR.

The database may store information that identifies a first set of NR cells that support VoNR, and/or the database may store information that identifies a second set of NR cells that do not support VoNR. In some aspects, the UE 120 may update the database based at least in part on historical information associated with the UE 120. For example, if the UE 120 determines that an NR cell triggers EPS fallback (e.g., based at least in part on receiving an EPS FB command on the NR cell), then the UE 120 may add a cell identifier of the NR cell (e.g., a cell global identify (CGI) of the NR cell) to the database and/or may add or modify a flag associated with the cell identifier to indicate that the NR cell triggers EPS fallback and/or does not support VoNR. Additionally, or alternatively, if the UE 120 determines that an NR cell does not trigger EPS fallback, then the UE 120 may remove a cell identifier of the NR cell from the database and/or may update a flag associated with the cell identifier to indicate that the NR cell does not trigger EPS fallback and/or that the NR cell does support VoNR. Additionally, or alternatively, the UE 120 and one or more other UEs 120 may provide such information regarding NR cells to a central device (e.g., in the network), and the central device may transmit periodic updates to the UE 120 to update a local database stored by the UE 120. Additionally, or alternatively, the UE 120 may transmit a cell identifier of an NR cell to the central device, and the central device may respond with an indication of whether the NR cell is associated with EPS fallback and/or an indication of whether the NR cell supports VoNR.

As shown by reference number 460, the UE 120 may perform a local connection release to release the communication connection with the NR cell 420. For example, the UE 120 may locally release the RRC connection with the NR cell 420. The UE 120 may release the communication connection with the NR cell 420 without receiving an indication or a command to release the communication connection from the NR cell 420. That is, the UE 120 may release the communication connection with the NR cell 420 based at least in part on receiving the indication to deprioritize the NR RAT from the modem 405 (e.g., and/or based at least in part on determining that the UE 120 is in an RRC connected mode with the NR cell 420). In some aspects, the UE 120 may perform the local connection release based at least in part on identifying an immediate NR connection release flag (e.g., Boolean flag) associated with the indication to deprioritize the NR RAT. For example, the modem 405 and/or the modem control interface may determine that the UE 120 is to immediately release any NR communication connection and may set the immediate NR connection release flag to true (e.g., to a value of 1). The UE 120 may perform the local connection release based at least in part on the immediate NR connection release flag being set to true (e.g., to a value of 1). If the immediate NR connection release flag is set to false (e.g., to a value of 0), then the UE 120 may not perform the local connection release. For example, the UE 120 (e.g., the modem 405, the modem control interface, and/or an application) may identify critical, high priority, and/or delay sensitive traffic to be transmitted by the UE 120. The UE 120 may set the immediate NR connection release flag to false to ensure that the critical, high priority, and/or delay sensitive traffic can be transmitted (e.g., to ensure that the NR RRC connection is not immediately released).

As shown by reference number 465, the UE 120 may trigger an NR to LTE redirection command. For example, the NR protocol stack 415 may transmit, to the LTE protocol stack 410, a redirection command that indicates that the UE 120 is to redirect from the NR RAT to the LTE RAT. Therefore, the UE 120 may perform an RRC connection release with redirection operation autonomously (e.g., without receiving a command or indication from the network). In some aspects, the UE 120 may perform the RRC connection release with redirection operation based at least in part on identifying an NR connection release flag (e.g., Boolean flag) associated with the indication to deprioritize the NR RAT. For example, the modem 405 and/or the modem control interface may determine that the UE 120 is to perform an RRC connection release with redirection operation and may set the NR connection release flag to true (e.g., to a value of 1). The UE 120 may perform the RRC connection release with redirection operation based at least in part on the NR connection release flag being set to true (e.g., to a value of 1). If the NR connection release flag is set to false (e.g., to a value of 0), then the UE 120 may not perform the RRC connection release with redirection operation.

The redirection command may indicate one or more LTE operating frequencies, identified by the UE 120, that are available for establishing an LTE connection. The UE 120 may identify the one or more LTE operating frequencies from a measurement object and/or a system information block (SIB) associated with and/or stored by the NR protocol stack 415. For example, the UE 120 may identify the one or more LTE operating frequencies from a MeasObjectEUTRA IE. The MeasObjectEUTRA IE may indicate information associated with intra-frequency or inter-frequency Evolved Universal Mobile Telecommunications System Terrestrial Radio Access (E-UTRA) cells. The content of the MeasObjectEUTRA IE may be defined, or otherwise fixed, by a 3GPP Specification. The measurement object may indicate operating frequencies and corresponding measurements (e.g., RSRP measurements) performed by the UE 120 while in the RRC connected mode. Additionally, or alternatively, the UE 120 may identify the one or more LTE operating frequencies from SIB5 of the NR protocol stack 415. SIB5 may indicate information for one or more E-UTRA frequencies and/or cells that are candidates for re-selection (e.g., may indicate information for inter system cell re-selection toward LTE). The content of SIB5 may be defined, or otherwise fixed, by a 3GPP Specification.

The UE 120 may transmit the one or more LTE operating frequencies (e.g., in the redirection command) in an ordered list. For example, the UE 120 may order the one or more LTE operating frequencies according to a priority level to enable the UE 120 to quickly identify and/or establish a communication using the LTE RAT (e.g., by placing a best LTE operating frequency first in the ordered list). For example, the UE 120 may order the one or more LTE operating frequencies by placing LTE operating frequencies identified in the measurement object (e.g., in the MeasObjectEUTRA IE) before LTE operating frequencies identified in the SIB (e.g., in SIB5) as the measurement object may indicate more recent measurements of the LTE operating frequencies. Within the LTE operating frequencies identified in the measurement object, the UE 120 may order the LTE operating frequencies based at least in part an amount of time since a measurement of each LTE operating frequency was performed and/or a measurement value (e.g., an RSRP value) of the measurements. For example, UE 120 may order recently measured (e.g., measured within a threshold amount of time) LTE operating frequencies before LTE operating frequencies that have not been recently measured (e.g., not measured within the threshold amount of time) or recently measured but not detected. For the recently measured LTE operating frequencies, the UE 120 may order the LTE operating frequencies by an RSRP value associated with the LTE operating frequencies (e.g., may place LTE operating frequencies with a higher RSRP value first in the list). As a result, the ordered list may enable the UE 120 to quickly identify and/or establish a connection using an LTE operating frequency.

As shown by reference number 470, upon transmitting the redirection command to the LTE protocol stack 410, the UE 120 may initiate a first timer (e.g., in the NR protocol stack 415). The first timer may be associated with preventing frequent RRC connection release with redirection commands by the UE 120. For example, if the UE 120 is unable to establish an LTE communication connection, the UE 120 may re-establish an NR communication connection (e.g., as described in more detail below). Re-establishing the NR communication connection may trigger the UE to initiate another RRC connection release with redirection operation (e.g., as the indication to deprioritize the NR RAT is persistent, as described above). Frequent RRC connection release with redirection operations may degrade communication performance of the UE 120 as the UE 120 may continually release the RRC connection without establishing an LTE connection. Therefore, the first timer may indicate an amount of time during which the UE 120 is to refrain from initiating another RRC connection release with redirection operation. For example, the UE 120 may refrain from performing another RRC connection release with redirection operation until after an expiration of the first timer. In some aspects, an amount of time associated with the first timer may be 5 seconds, 10 seconds, 15 second, and/or 30 seconds, among other examples.

As shown by reference number 475, upon transmitting the redirection command to the LTE protocol stack 410, the UE 120 may initiate a second timer (e.g., in the LTE protocol stack 410). The second timer may be associated with preventing the UE 120 from continually attempting to establish an LTE communication connection. For example, as shown by reference number 480, the UE 120 may attempt to establish an LTE communication using the one or more LTE operating frequencies indicated in the redirection command. In some aspects, the UE 120 may be unable to establish an LTE communication using the one or more LTE operating frequencies (e.g., the UE 120 may be outside of a communication range of an LTE cell, such as the LTE cell 425). The UE 120 may re-establish an NR communication connection (e.g., with the NR cell 420) if the UE 120 is unable to establish an LTE communication using the one or more LTE operating frequencies after an expiration of the second timer. Therefore, the UE 120 may resume communicating using the NR RAT if the LTE RAT is unavailable, thereby improving communication performance of the UE 120 (e.g., when compared with communicating using a 2G RAT or a 3G RAT). In some aspects, the second timer may be associated with a less amount of time than an amount of time associated with the first timer.

As shown by reference number 485, the UE 120 and the LTE cell 425 may perform a tracking area update (TAU). The TAU may enable the UE 120 to establish a communication connection with the LTE cell 425. For example, the LTE cell 425 may be associated with an LTE operating frequency identified in the redirection command, as described above. The TAU may include the UE 120 transmitting, to the LTE cell 425 (e.g., a base station associated with the LTE cell 425) a TAU request that indicates UE capability information and/or a request to establish a communication connection. The LTE cell 425 may transmit, to the UE 120, a TAU response that initiates and/or establishes an RRC connection. As shown by reference number 490, after establishing the RRC connection with the LTE cell 425, the UE 120 and the LTE cell 425 may communicate data between the UE 120 and the LTE cell 425.

As a result, the UE 120 is enabled to deprioritize the NR RAT when operating in an NR RRC connected mode by autonomously performing an RRC connection release with redirection to LTE. The redirection may indicate an ordered list of one or more LTE operating frequencies to enable the UE 120 to quickly establish an LTE RRC connection to quickly resume data transfer. Moreover, the UE 120 is enabled to re-establish an NR RRC connection if an LTE connection cannot be established.

As indicated above, FIG. 4 is provided as an example. Other examples may differ from what is described with regard to FIG. 4.

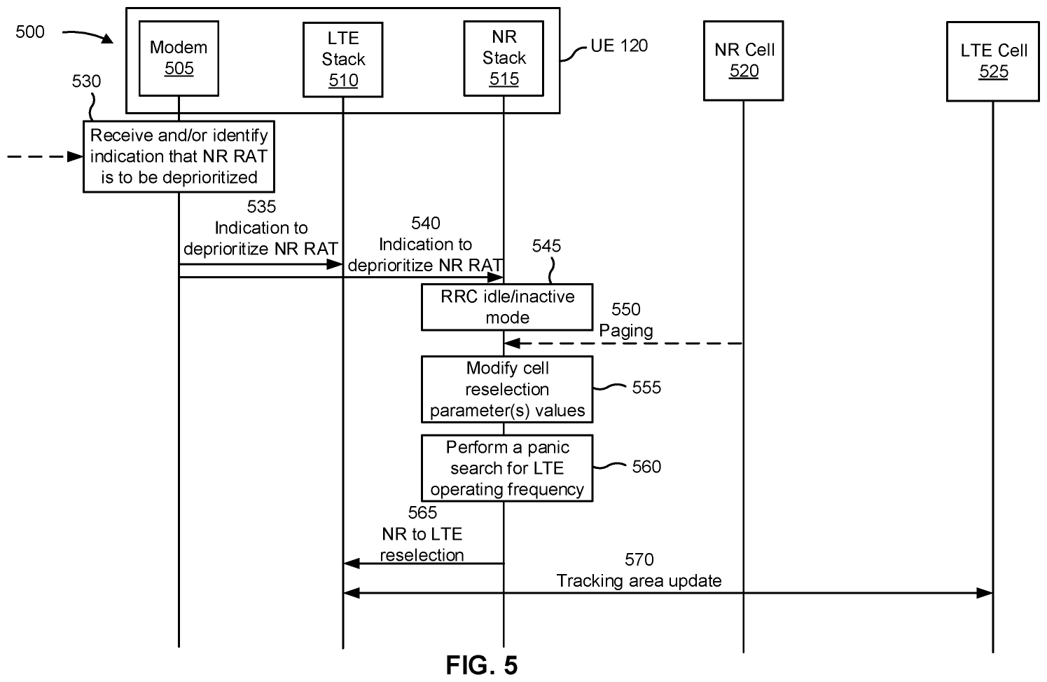

FIG. 5 is a diagram illustrating an example 500 associated with RAT deprioritization, in accordance with the present disclosure. FIG. 5 shows a signaling diagram for a UE 120 in communication with an NR cell 520 (e.g., with a base station 110 associated with the NR cell 520) using a modem 505. The UE 120 may include an LTE protocol stack 510 and an NR protocol stack 515. The UE 120 (e.g., the modem 505, the LTE protocol stack 510, and/or the NR protocol stack 515) may be similar to (or the same as) the UE 120 (e.g., the modem 405, the LTE protocol stack 410, and/or the NR protocol stack 415) described above in connection with FIG. 4. As shown in FIG. 5, the UE 120 may communicate with the NR cell 520 and/or an LTE cell 525.

As shown by reference number 530, the UE 120 may determine that the NR RAT should be deprioritized. For example, the UE 120 (e.g., the modem 405) may determine that the NR RAT should be deprioritized based at least in part on detecting or identifying a trigger event and/or based at least in part on receiving an indication to deprioritize the NR RAT (e.g., from a modem control interface and/or an application), as described in more detail above in connection with FIG. 4. As shown by reference number 535, based at least in part on receiving or identifying the indication to deprioritize the NR RAT, the modem 505 may transmit, to the LTE protocol stack 510, an indication to deprioritize the NR RAT (e.g., may set a flag associated with the LTE protocol stack 510 to true or a value of 1). Similarly, as shown by reference number 540, based at least in part on receiving or identifying the indication to deprioritize the NR RAT, the modem 505 may transmit, to the NR protocol stack 515, an indication to deprioritize the NR RAT (e.g., may set a flag associated with the NR protocol stack 515 to true or a value of 1).

As shown by reference number 545, in example 500, the UE 120 may establish a communication connection with the NR cell 520 in an RRC idle mode or an RRC inactive mode. For example, the UE 120 may be in the RRC idle mode or the RRC inactive mode with the NR cell 520 when receiving or identifying the indication to deprioritize the NR RAT. In some aspects, the UE 120 may be in the RRC idle mode or the RRC inactive mode with the NR cell 520 while a flag associated with deprioritizing the NR is set to true or a value of 1. For example, the UE 120 may receive or identify the indication to deprioritize the NR RAT and may transition to the RRC idle mode or the RRC inactive mode and/or may establish the communication connection with the NR cell 520 before the indication to deprioritize the NR RAT is canceled (e.g., before a flag associated with deprioritizing the NR is set to false or a value of 0). For example, the indication to deprioritize the NR RAT may be received while the UE 120 is in an RRC connected mode with the NR cell 520 (e.g., as described above in connection with FIG. 4). The UE 120 may transition to the RRC idle mode or the RRC inactive mode from the RRC connected mode while a flag associated with deprioritizing the NR is still set to true or a value of 1.

As shown by reference number 550, the UE 120 may monitor for paging from the NR cell 520 while operating in the RRC idle mode or the RRC inactive mode. For example, the UE 120 may be configured with a DRX cycle that includes an on or active portion of time during which the UE 120 is to monitor for paging or perform measurements of the NR cell 520 and/or other neighboring cells. The DRX cycle may include an inactive or idle time during which the UE 120 may enter a sleep state and may not monitor for communication (e.g., paging) and/or perform measurements.

As shown by reference number 555, the indication to deprioritize the NR RAT transmitted by the modem 505 may indicate that one or more cell reselection criteria parameters associated with the NR RAT are to be modified. The one or more cell reselection criteria parameters may include a cell reselection priority parameter for one or more operating frequencies associated with the NR RAT, a cell reselection receive signal level (Srxlev) threshold parameter for reselecting to a higher priority RAT from a lower priority RAT (e.g., a ThreshX, HighP parameter as defined, or otherwise fixed, by the 3GPP Specifications), an Srxlev threshold parameter for reselecting to a lower priority RAT from a higher priority RAT (e.g., a ThreshX, LowP parameter as defined, or otherwise fixed, by the 3GPP Specifications), a cell reselection receive signal quality (Squal) threshold parameter for reselecting to a higher priority RAT from a lower priority RAT (e.g., a ThreshX, HighQ parameter as defined, or otherwise fixed, by the 3GPP Specifications), or an Squal threshold parameter for reselecting to a lower priority RAT from a higher priority RAT (e.g., a ThreshX, LowQ parameter as defined, or otherwise fixed, by the 3GPP Specifications), among other examples. An Srxlev threshold parameter may indicate an RSRP value associated with the Srxlev threshold parameter. An Squal threshold parameter may indicate an RSRQ value associated with the Squal threshold parameter.

The UE 120 may modify a value of the one or more cell reselection criteria parameters associated with the NR RAT. For example, the UE 120 may modify a cell reselection priority parameter for one or more (or all) NR operating frequencies. In some aspects, the wireless network (e.g., the NR cell 520) may indicate cell reselection priority parameter values the NR operating frequencies in an RRC configuration. In some aspects, the values of the cell reselection priority parameter may range from zero to seven (e.g., where a value of zero indicates a lowest priority and a value of seven indicates a highest priority). The cell reselection priority parameter values for the NR operating frequencies may be indicated in a CellReselectionPriority IE of a SIB. For example, the cell reselection priority parameter values for the NR operating frequencies may be indicated in a CellReselectionPriority IE of SIB2/4 stored by the NR protocol stack 515.

In some aspects, the UE 120 may modify a value of the cell reselection priority parameter for one or more (or all) NR operating frequencies to lower the priority of the NR operating frequencies. In some aspects, the UE 120 may modify a value of the cell reselection priority parameter for one or more (or all) LTE operating frequencies to raise the priority of the LTE operating frequencies, which may be configured by a CellReselectionPriority IE of SIB5.

In some aspects, the UE 120 may modify the values of the cell reselection priority parameter for one or more (or all) NR operating frequencies such that the values of the cell reselection priority parameter for one or more (or all) NR operating frequencies are less than zero (e.g., indicating that the NR operating frequencies have a lowest priority). In some aspects, the UE 120 may modify an Srxlev threshold parameter for reselecting from the NR RAT to the LTE RAT in a SIB (e.g., SIB5) stored by the NR protocol stack 515. In some aspects, the UE 120 may modify an Squal threshold parameter for reselecting from the NR RAT to the LTE RAT in a SIB (e.g., SIB5) stored by the NR protocol stack 515. For example, the UE 120 may modify a value of the Srxlev threshold parameter and/or a value of the Squal threshold parameter for reselecting from the NR RAT to the LTE RAT to lower values (e.g., than values configured by the NR cell 520).

As a result, the UE 120 may deprioritize the NR RAT and prioritize the LTE RAT when performing cell reselection procedures in the NR RRC idle mode or the NR RRC inactive mode (e.g., by reducing the threshold levels for reselecting from the NR RAT to the LTE RAT in the NR protocol stack 515). In some aspects, if the LTE RAT has a higher priority than the NR RAT (e.g., as indicated by the cell reselection priority parameter), then the Srxlev threshold parameter for reselecting from the NR RAT to the LTE RAT may be the ThreshX, HighP parameter. Similarly, if the LTE RAT has a higher priority than the NR RAT, then the Squal threshold parameter for reselecting from the NR RAT to the LTE RAT may be the ThreshX, HighQ parameter.

As shown by reference number 560, the UE 120 the indication(s) to deprioritize the NR RAT transmitted by the modem 505 may indicate that the UE 120 is to perform a panic search to identify one or more LTE operating frequencies and measure LTE operating frequencies in order to perform reselection to the LTE RAT. A panic search may include suspending or delaying a search procedure for NR operating frequencies, refraining from entering a sleep state associated with the RRC idle mode or the RRC inactive mode (e.g., associated with a configured DRX cycle) or performing a wakeup from the sleep state associated with the RRC idle mode or the RRC inactive mode, and continuously performing a search procedure for one or more LTE operating frequencies. The one or more LTE operating frequencies may be identified by the UE 120 in SIB5 of the NR protocol stack 515. In some aspects, the UE 120 may initiate a panic search timer upon initiating the panic search. The UE 120 may terminate the panic search after an expiration of the timer to conserve power resources (e.g., as the panic search may consume high amounts of power).

As shown by reference number 565, the UE 120 may transmit, from the NR protocol stack 515 to the LTE protocol stack 510, an NR to LTE reselection command. The NR to LTE reselection command may indicate one or more LTE operating frequencies (e.g., identified based at least in part on performing the panic search). In some aspects, the NR to LTE reselection command may include a panic search indication (e.g., indicating that the NR to LTE reselection command is associated with the panic search performed by the UE 120).

As shown by reference number 570, the UE 120 and the LTE cell 525 may perform a TAU. The TAU may enable the UE 120 to establish a communication connection with the LTE cell 525. For example, the LTE cell 525 may be associated with an LTE operating frequency identified in the reselection command, as described above. The TAU may include the UE 120 transmitting, to the LTE cell 525 (e.g., a base station associated with the LTE cell 525) a TAU request that indicates UE capability information and/or a request to establish a communication connection. The LTE cell 525 may transmit, to the UE 120, a TAU response that initiates and/or establishes an RRC connection. After establishing the RRC connection with the LTE cell 525, the UE 120 and the LTE cell 525 may communicate data between the UE 120 and the LTE cell 525.

As a result, the UE 120 is enabled to deprioritize the NR RAT when operating in an NR RRC idle mode or an NR RRC inactive mode by deprioritizing the NR RAT in cell reselection when performing cell reselection procedures in the NR RRC idle mode or the NR RRC inactive mode (e.g., by reducing the threshold levels for reselecting from the NR RAT to the LTE RAT in the NR protocol stack 515) and/or by performing a panic search to identify one or more LTE operating frequencies.

As indicated above, FIG. 5 is provided as an example. Other examples may differ from what is described with regard to FIG. 5.

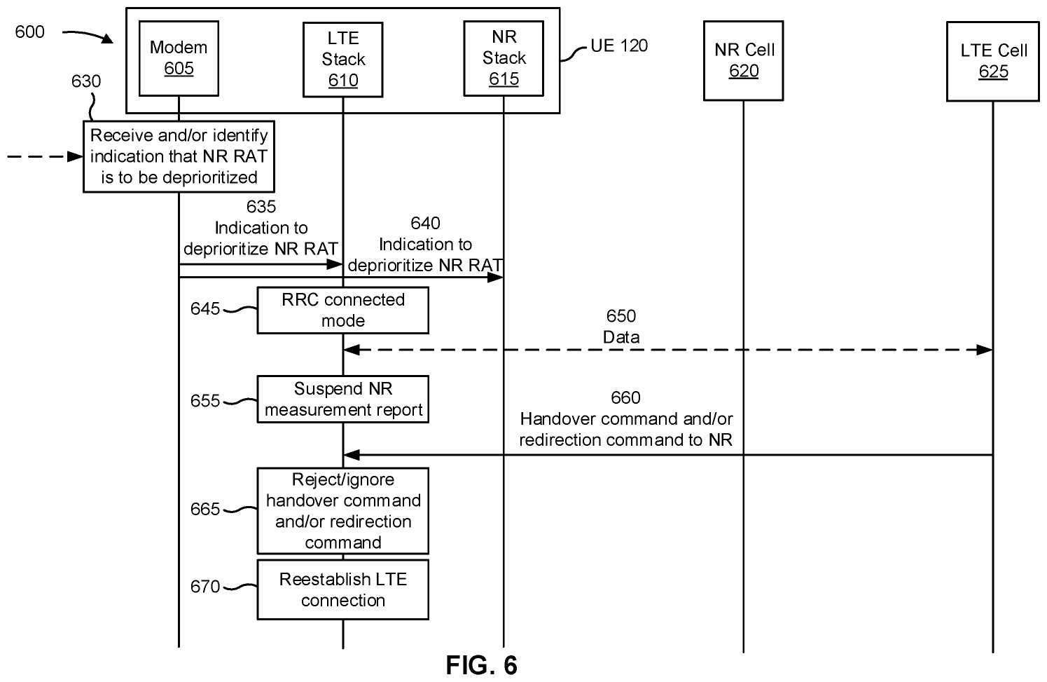

FIG. 6 is a diagram illustrating an example 600 associated with RAT deprioritization, in accordance with the present disclosure. FIG. 6 shows a signaling diagram for a UE 120 in communication with an LTE cell 625 (e.g., with a base station 110 associated with the LTE cell 625) using a modem 605. The UE 120 may include an LTE protocol stack 610 and an NR protocol stack 615. The UE 120 (e.g., the modem 605, the LTE protocol stack 610, and/or the NR protocol stack 615) may be similar to (or the same as) the UE 120 described above in connection with FIGS. 4 and 5. As shown in FIG. 6, the UE 120 may communicate with an NR cell 620 and/or the LTE cell 625.

As shown by reference number 630, the UE 120 may determine that the NR RAT should be deprioritized. For example, the UE 120 (e.g., the modem 605) may determine that the NR RAT should be deprioritized based at least in part on detecting or identifying a trigger event and/or based at least in part on receiving an indication to deprioritize the NR RAT (e.g., from a modem control interface and/or an application), as described in more detail above in connection with FIG. 4. As shown by reference number 635, based at least in part on receiving or identifying the indication to deprioritize the NR RAT, the modem 605 may transmit, to the LTE protocol stack 610, an indication to deprioritize the NR RAT (e.g., may set a flag associated with the LTE protocol stack 610 to true or a value of 1). Similarly, as shown by reference number 640, based at least in part on receiving or identifying the indication to deprioritize the NR RAT, the modem 605 may transmit, to the NR protocol stack 615, an indication to deprioritize the NR RAT (e.g., may set a flag associated with the NR protocol stack 615 to true or a value of 1).

As shown by reference number 645, in example 600, the UE 120 may establish a communication connection with the LTE cell 625 in an RRC connected mode. For example, the UE 120 may be in the RRC connected mode with the LTE cell 625 when receiving or identifying the indication to deprioritize the NR RAT. In some aspects, the UE 120 may be in the RRC connected mode with the LTE cell 625 while a flag associated with deprioritizing the NR is set to true or a value of 1. For example, the UE 120 may receive or identify the indication to deprioritize the NR RAT and may transition to the RRC connected mode and/or may establish the communication connection with the LTE cell 625 before the indication to deprioritize the NR RAT is canceled (e.g., before a flag associated with deprioritizing the NR is set to false or a value of 0). In some aspects, the UE 120 may transition to the LTE RRC connected mode from an NR communication mode after performing one or more of the operations described above in connection with FIGS. 4 and 5. As shown by reference number 650, in some aspects, the UE 120 and the LTE cell 625 may communicate data between the UE 120 and the LTE cell 625 while in the RRC connected mode.

As shown by reference number 655, the indication to deprioritize the NR RAT may indicate that the UE 120 is to suspend transmission of NR measurement reports. For example, the UE 120 may be configured to transmit a measurement report (e.g., to the LTE cell 625) indicating an NR operating frequency if a measurement of the NR operating frequency satisfies a threshold (e.g., a B1 measurement report as defined, or otherwise fixed, in a 3GPP Specification). The UE 120 may refrain from transmitting a measurement report indicating an NR operating frequency based at least in part on receiving or identifying the indication to deprioritize the NR RAT. As a result, the NR RAT may be deprioritized as the LTE cell 625 may not receive measurement reports indicating NR operating frequencies. Therefore, the LTE cell 625 may not be enabled to initiate a handover procedure to an NR cell (e.g., an NR operating frequency).

As shown by reference number 660, in some aspects, the LTE cell 625 may transmit, to the UE 120, a handover command and/or a redirection command to an NR operating frequency and/or an NR cell, such as the NR cell 620. For example, the LTE cell 625 may transmit the handover command and/or the redirection command based at least in part on one or more measurement reports transmitted by the UE 120 (e.g., prior to suspending the transmission of NR measurement reports, as described above).

As shown by reference number 665, the UE 120 may reject and/or ignore the handover command and/or the redirection command received from the LTE cell 625. For example, for a handover command received from the LTE cell 625 (e.g., from a base station associated with the LTE cell 625), the UE 120 may refrain from establishing an NR communication connection. In other words, after receiving the handover command, the UE 120 may not take an action associated with establishing an NR communication connection and/or performing a handover procedure to an NR cell (e.g., the UE 120 may ignore the handover command). Rather, as shown by reference number 670, the UE 120 may perform an operation to reestablish the RRC connection with the LTE cell 625. For example, the UE 120 may transmit, to the LTE cell 625, an RRC connection reestablishment request (e.g., as defined, or otherwise fixed, by the 3GPP Specifications). The RRC connection reestablishment request may enable the UE 120 and the LTE cell 625 to reestablish the LTE RRC connection.

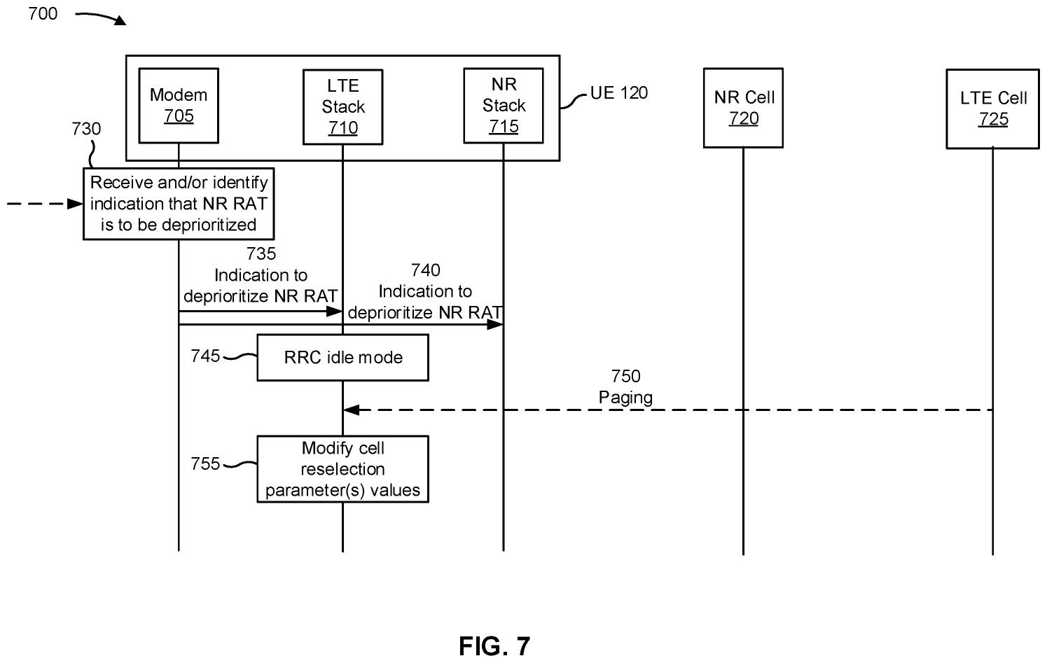

For a redirection to NR command received from the LTE cell 625 (e.g., from a base station associated with the LTE cell 625), the UE 120 may perform an operation to release the RRC connected mode connection with the LTE cell 625. The UE 120 may refrain from establishing an NR communication connection as indicated by the redirection command. Rather, the UE 120 may transition to an RRC idle mode connection with the LTE cell 625. In some aspects, the UE 120 may perform one or more operations described below in connection with FIG. 7 after transitioning to the RRC idle mode connection with the LTE cell 625.

In some aspects, the UE 120 may reject and/or ignore the handover command and/or the redirection command received from the LTE cell 625 based at least in part on identifying a reject LTE to NR handover (HO) flag (e.g., Boolean flag) associated with the indication to deprioritize the NR RAT. For example, the modem 605 and/or the modem control interface may determine that the UE 120 is to reject and/or ignore the handover command and/or the redirection command received from an LTE cell and may set the reject LTE to NR HO flag to true (e.g., to a value of 1). The UE 120 may reject and/or ignore a handover command and/or a redirection command (e.g., as described above) based at least in part on the reject LTE to NR HO flag being set to true (e.g., to a value of 1). If the reject LTE to NR HO flag is set to false (e.g., to a value of 0), then the UE 120 may follow a handover command and/or a redirection command received from the LTE cell 625.

As a result, the UE 120 is enabled to deprioritize the NR RAT when operating in an LTE RRC connected mode by suspending the transmission of NR measurement reports and/or by rejecting/ignoring a handover command and/or a redirection command received from an LTE cell. As a result, the UE 120 may prioritize remaining in an LTE connection and may deprioritize establishing an NR connection.

As indicated above, FIG. 6 is provided as an example. Other examples may differ from what is described with regard to FIG. 6.

FIG. 7 is a diagram illustrating an example 700 associated with RAT deprioritization, in accordance with the present disclosure. FIG. 7 shows a signaling diagram for a UE 120 in communication with an LTE cell 725 (e.g., with a base station 110 associated with the LTE cell 725) using a modem 705. The UE 120 may include an LTE protocol stack 710 and an NR protocol stack 715. The UE 120 (e.g., the modem 705, the LTE protocol stack 710, and/or the NR protocol stack 715) may be similar to (or the same as) the UE 120 described above in connection with FIGS. 4, 5, and 6. As shown in FIG. 7, the UE 120 may communicate with an NR cell 720 and/or the LTE cell 725.

As shown by reference number 730, the UE 120 may determine that the NR RAT should be deprioritized. For example, the UE 120 (e.g., the modem 705) may determine that the NR RAT should be deprioritized based at least in part on detecting or identifying a trigger event and/or based at least in part on receiving an indication to deprioritize the NR RAT (e.g., from a modem control interface and/or an application), as described in more detail above in connection with FIG. 4. As shown by reference number 735, based at least in part on receiving or identifying the indication to deprioritize the NR RAT, the modem 705 may transmit, to the LTE protocol stack 710, an indication to deprioritize the NR RAT (e.g., may set a flag associated with the LTE protocol stack 710 to true or a value of 1). Similarly, as shown by reference number 740, based at least in part on receiving or identifying the indication to deprioritize the NR RAT, the modem 705 may transmit, to the NR protocol stack 715, an indication to deprioritize the NR RAT (e.g., may set a flag associated with the NR protocol stack 715 to true or a value of 1).

As shown by reference number 745, in example 700, the UE 120 may establish a communication connection with the LTE cell 725 in an RRC idle mode. For example, the UE 120 may be in the RRC idle mode with the LTE cell 725 when receiving or identifying the indication to deprioritize the NR RAT. In some aspects, the UE 120 may be in the RRC idle mode with the LTE cell 725 while a flag associated with deprioritizing the NR is set to true or a value of 1. For example, the UE 120 may receive or identify the indication to deprioritize the NR RAT and may transition to the RRC idle mode and/or may establish the communication connection with the LTE cell 725 before the indication to deprioritize the NR RAT is canceled (e.g., before a flag associated with deprioritizing the NR is set to false or a value of 0). For example, the indication to deprioritize the NR RAT may be received while the UE 120 is in an RRC connected mode with the NR cell 720 (e.g., as described above in connection with FIG. 4) and/or with the LTE cell 725 (e.g., as described above in connection with FIG. 6). The UE 120 may transition to the RRC idle mode from the RRC connected mode while a flag associated with deprioritizing the NR is still set to true or a value of 1.

As shown by reference number 750, the UE 120 may monitor for paging from the LTE cell 725 while operating in the RRC idle mode. For example, the UE 120 may be configured with a DRX cycle that includes an on or active portion of time during which the UE 120 is to monitor for paging or perform measurements of the LTE cell 725 and/or other neighboring cells. The DRX cycle may include an inactive or idle time during which the UE 120 may enter a sleep state and may not monitor for communication (paging) and/or perform measurements.

As shown by reference number 755, the indication to deprioritize the NR RAT transmitted by the modem 705 may indicate that one or more cell reselection criteria parameters associated with the NR RAT are to be modified. The one or more cell reselection criteria parameters may be similar to (or the same as) the one or more cell reselection criteria parameters described above in connection with FIG. 5. For example, the UE 120 may modify a value of the cell reselection priority parameter for one or more (or all) NR operating frequencies to lower the priority of the NR operating frequencies. The UE 120 may modify the values of the cell reselection priority parameter for one or more (or all) NR operating frequencies in the CellReselectionPriority IE of SIB24 stored by the LTE protocol stack 710. In some aspects, the UE 120 may modify a value of the cell reselection priority parameter for one or more (or all) LTE operating frequencies to raise the priority of the LTE operating frequencies.

In some aspects, the UE 120 may modify an Srxlev threshold parameter for reselecting from the LTE RAT to the NR RAT in a SIB (e.g., SIB24) stored by the LTE protocol stack 710. In some aspects, the UE 120 may modify an Squal threshold parameter for reselecting from the LTE RAT to the NR RAT in a SIB (e.g., SIB24) stored by the LTE protocol stack 710. For example, the UE 120 may modify a value of the Srxlev threshold parameter and/or a value of the Squal threshold parameter for reselecting from the LTE RAT to the NR RAT to higher values (e.g., than values configured by the LTE cell 725). Therefore, the threshold level of a measured Srxlev and/or a measured Squal that is required trigger a reselection procedure from the LTE RAT to the NR RAT is increased.

As a result, the UE 120 may deprioritize the NR RAT and prioritize the LTE RAT when performing cell reselection procedures (e.g., by increasing the threshold levels for reselecting from the LTE RAT to the NR RAT in the LTE protocol stack 710). In some aspects, if the LTE RAT has a higher priority than the NR RAT (e.g., as indicated by the cell reselection priority parameter), the Srxlev threshold parameter for reselecting from the LTE RAT to the NR RAT may be the ThreshX, LowP parameter. Similarly, if the LTE RAT has a higher priority than the NR RAT, the Squal threshold parameter for reselecting from the LTE RAT to the NR RAT may be the ThreshX, LowQ parameter.

As described above, the indication to deprioritize the NR RAT may be persistent (e.g. may remain in place until canceled or changed). Therefore, the UE 120 may perform one or more of the operations described herein in connection with FIGS. 4, 5, 6, and 7. For example, a UE 120 may be in an NR RRC connected mode and may perform one or more (or all) of the operations described above in connection with FIG. 4 to establish an LTE connection in an RRC connected mode. If the indication to deprioritize the NR RAT remains (e.g., if the flag associated with indication to deprioritizing the NR is still set to true or a value of 1), then the UE 120 may perform one or more (or all) of the operations described above in connection with FIG. 6 to deprioritize the NR RAT and remain connected to the LTE RAT. As another example, the UE 120 may be in an NR RRC connected mode and may perform one or more (or all) of the operations described above in connection with FIG. 4. The UE 120 may be unable to establish an LTE connected and may enter an NR RRC idle mode or inactive mode. If the indication to deprioritize the NR RAT remains (e.g., if the flag associated with indication to deprioritizing the NR is still set to true or a value of 1), then the UE 120 may perform one or more (or all) of the operations described above in connection with FIG. 5 to deprioritize the NR RAT. Therefore, the operations and/or actions performed by the UE 120 to deprioritize the NR RAT may be based at least in part on the RRC communication mode and/or the RAT that the UE is currently operating in.

As a result, the operations and/or actions described herein in connected with FIGS. 4, 5, 6, and 7 may enable a signaling overhead associated with deprioritizing the NR RAT to be reduced (e.g., eliminated) as the UE is not required to update capability information of the UE 120 to a base station when deprioritizing the NR RAT. Moreover, by deprioritizing the NR RAT as described above, the UE deprioritizes the NR RAT, but does not eliminate the possibility of switching to the NR RAT. As a result, if an LTE communication link becomes poor or unstable (or fails) while the NR RAT is deprioritized, the UE 120 may still reselect to an NR cell, rather than being required to reselect to a 2G cell or a 3G cell. Communicating using the NR cell rather a 2G cell or a 3G cell when an LTE communication link becomes poor or unstable (or fails) improves a communication performance of the UE 120.

Moreover, the UE 120 may perform different actions based at least in part on the RRC communication mode and/or the RAT that the UE 120 is currently using to communicate. Therefore, the UE 120 may be enabled to maintain a deprioritization of the NR RAT if the UE 120 transitions to a different RRC communication mode and/or establishes a communication connection with a different RAT. By deprioritizing the NR RAT as described above, the UE 120 may ensure that capabilities required by the UE 120, such as a voice capability, are available to the UE 120. Moreover, the UE 120 may conserve battery and/or power resources that would have otherwise been consumed using the NR RAT (e.g., rather than the LTE RAT).

As indicated above, FIG. 7 is provided as an example. Other examples may differ from what is described with regard to FIG. 7.

Examples described herein (e.g., in connection with FIGS. 4-9) may similarly be applied to deprioritize certain cells. For example, a trigger that is external to a modem of a UE may be used to deprioritize one or more cells. For example, the indication to deprioritize a RAT (e.g., as described in connection with reference numbers 430, 435, 440, 530, 535, 540, 630, 635, 640, 730, 735, and/or 740) may indicate that one or more cells (e.g., associated with a RAT or multiple RATs) are to be deprioritized. In some aspects, the indication may include a set or list of cells to be deprioritized. In other words, the deprioritization may be on a cell level (e.g., a per-cell level) rather than on a RAT level. For example, the indication may be a flag provided to the modem of the UE that indicates a list of cells to be deprioritized. In some aspects, the flag may be a persistent flag (e.g., that indicates that cells included in the list are to be deprioritized by the UE).

The indication (e.g., the trigger) to deprioritize the one or more cells may be based at least in part on a performance of the one or more cells. In other words, the indication (e.g., the trigger) to deprioritize a cell may be based at least in part on poor performance of the cell. For example, the indication (e.g., the trigger) to deprioritize a cell may be based at least in part on a metric associated with the cell not satisfying a threshold. For example, the metric may be a block error rate (BLER) associated with the cell, a cell loading, a latency, a signal strength, a signal quality, connection setup failure or rejection rate, and/or radio link failure rate in connected mode, among other examples. In some aspects, the indication (e.g., the trigger) to deprioritize a cell may be based at least in part on a cell failure of the cell. For example, a cell may be deprioritized based at least in part on a quantity of cell failures associated with the cell satisfying a threshold.

The action taken by the UE (e.g., by the modem of the UE) based at least in part on receiving the external indication (e.g., the trigger) to deprioritize the one or more cells may include a system selection action. For example, the UE may refrain from selecting a cell included in the one or more cells (e.g., unless no other cell is available). For example, the UE may avoid selection of a deprioritized cell (e.g., included in the one or more cells) unless no other suitable cell (e.g., a cell that is associated with a metric that satisfies a cell search or cell selection threshold) is available. As another example, the action taken by the UE (e.g., by the modem of the UE) based at least in part on receiving the external indication (e.g., the trigger) to deprioritize the one or more cells may include a system reselection action. For example, the UE may refrain from reselecting to a cell included in the one or more cells. The UE may refrain from reselecting to a cell included in the one or more cells unless a metric (e.g., an RSRP or an RSRQ) of a serving cell of the UE is less than a first threshold modified by a first offset value (e.g., decreased by the first offset value) and a metric of the cell is greater than a second threshold modified by a second offset value (e.g., increased by the second offset value). For example, the first threshold may be a serving cell low power threshold (e.g., a threshServingLowP parameter) or a serving cell low quality threshold (e.g., a threshServingLowQ parameter), among other examples. The second threshold may be the ThreshX, LowP parameter or the ThreshX, LowQ parameter.

In some aspects, the UE may be handed over (e.g., as part of a handover procedure) to a cell included in the one or more cells to be deprioritized. In such examples, the action taken by the UE (e.g., by the modem of the UE) based at least in part on receiving the external indication (e.g., the trigger) to deprioritize the one or more cells may include initiating a radio link failure (RLF) based at least in part on performing a handover with a cell included in the one or more cells. For example, the UE may initiate an RLF with the deprioritized cell and may re-establish a connection with another cell (e.g., that is not included in the one or more cells to be deprioritized, unless no other suitable cells are available). In some aspects, the UE may be connected to a deprioritized cell (e.g., when the modem receives the indication to deprioritize the one or more cells). In such examples, the action taken by the UE (e.g., by the modem of the UE) based at least in part on receiving the external indication (e.g., the trigger) to deprioritize the one or more cells may include initiating an RLF based at least in part on being connected to the cell included in the one or more cells. For example, the UE may initiate an RLF with the deprioritized cell and may re-establish a connection with another cell (e.g., that is not included in the one or more cells to be deprioritized, unless no other suitable cells are available). As a result, deprioritization may be performed on a cell-level, rather than a RAT level. As described elsewhere herein, this may enable a signaling overhead associated with deprioritizing a cell to be reduced (e.g., eliminated) as the UE is not required to update capability information of the UE to a base station when deprioritizing the cell. Moreover, by deprioritizing the cell as described above, the UE deprioritizes the cell, but does not eliminate the possibility of switching to the cell. As a result, if a link becomes poor or unstable (or fails) while the cell is deprioritized, the UE may still reselect to the cell, rather than being required to reselect to a 2G cell or a 3G cell.

FIG. 8 is a diagram illustrating an example process 800 performed, for example, by a UE, in accordance with the present disclosure. Example process 800 is an example where the UE (e.g., UE 120) performs operations associated with techniques for RAT deprioritization.

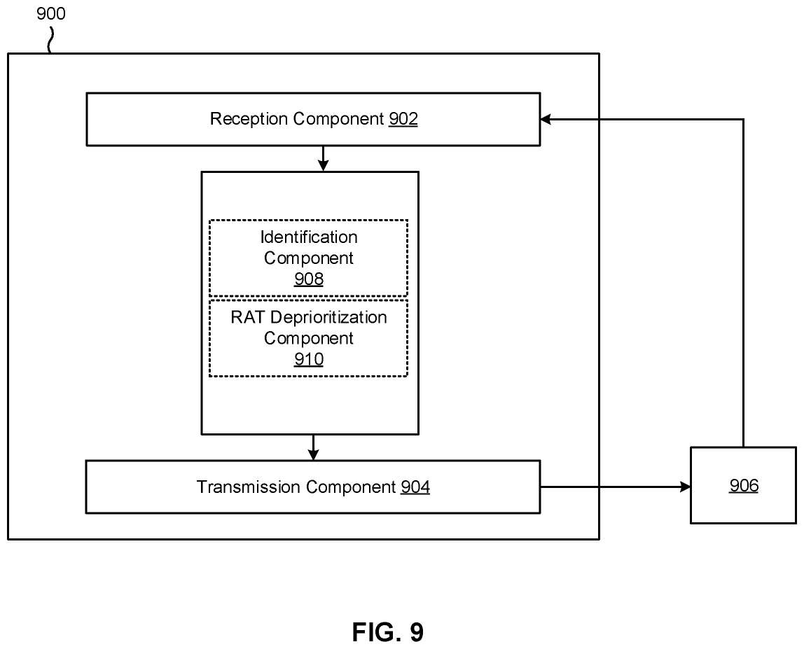

As shown in FIG. 8, in some aspects, process 800 may include establishing, in a communication mode, a communication connection with a first RAT or a second RAT (block 810). For example, the UE (e.g., using reception component 902 and/or the transmission component 904, depicted in FIG. 9) may establish, in a communication mode, a communication connection with a first RAT or a second RAT, as described above.

As further shown in FIG. 8, in some aspects, process 800 may include receiving or identifying an indication to deprioritize the first RAT (block 820). For example, the UE (e.g., using reception component 902 and/or identification component 908, depicted in FIG. 9) may receive or identify an indication to deprioritize the first RAT, as described above.

As further shown in FIG. 8, in some aspects, process 800 may include performing, based at least in part on the indication to deprioritize the first RAT, an action to deprioritize the first RAT, wherein the action is based at least in part in the communication mode (block 830). For example, the UE (e.g., using RAT deprioritization component 910, depicted in FIG. 9) may perform, based at least in part on the indication to deprioritize the first RAT, an action to deprioritize the first RAT, wherein the action is based at least in part in the communication mode, as described above.

Process 800 may include additional aspects, such as any single aspect or any combination of aspects described below and/or in connection with one or more other processes described elsewhere herein.

In a first aspect, establishing the communication connection comprises establishing a first communication connection with the first RAT, and performing the action to deprioritize the first RAT comprises terminating the first communication connection with the first RAT, and establishing a second communication connection with the second RAT.

In a second aspect, establishing the communication connection comprises establishing a first communication connection with the second RAT, and performing the action to deprioritize the first RAT comprises maintaining the first communication connection with the second RAT, and refraining from establishing a second communication connection with the first RAT.

In a third aspect, alone or in combination with one or more of the first and second aspects, process 800 includes transmitting, by the modem of the UE and to a first RAT protocol stack of the UE, an indication to deprioritize the first RAT, and transmitting, by the modem of the UE and to a second RAT protocol stack of the UE, an indication to deprioritize the first RAT.

In a fourth aspect, alone or in combination with one or more of the first through third aspects, receiving or identifying the indication to deprioritize the first RAT comprises receiving, from an API, the indication to deprioritize the first RAT.

In a fifth aspect, alone or in combination with one or more of the first through third aspects, receiving or identifying the indication to deprioritize the first RAT comprises identifying a trigger to deprioritize the first RAT.

In a sixth aspect, alone or in combination with one or more of the first through fifth aspects, establishing the communication connection comprises establishing, in a connected communication mode, a communication connection with the first RAT.

In a seventh aspect, alone or in combination with the sixth aspect, performing the action to deprioritize the first RAT comprises performing a local release of the communication connection with the first RAT.

In an eighth aspect, alone or in combination with one or more of the sixth through seventh aspects, performing the action to deprioritize the first RAT comprises performing an operation to autonomously release the communication connection with a redirection to the second RAT.

In a ninth aspect, alone or in combination with one or more of the sixth through eighth aspects, performing the action to deprioritize the first RAT comprises transmitting, from a first RAT protocol stack of the UE and to a second RAT protocol stack of the UE, a redirection command indicating one or more second RAT operating frequencies.

In a tenth aspect, alone or in combination with the ninth aspect, process 800 includes identifying the one or more second RAT operating frequencies from a second RAT measurement object or a system information block of the first RAT protocol stack.

In an eleventh aspect, alone or in combination with one or more of the ninth through tenth aspects, transmitting the redirection command indicating the one or more second RAT operating frequencies comprises transmitting, from the first RAT protocol stack of the UE and to the second RAT protocol stack of the UE, the redirection command indicating the one or more second RAT operating frequencies in a prioritized order.

In a twelfth aspect, alone or in combination with the eleventh aspect, transmitting the redirection command indicating the one or more second RAT operating frequencies in the prioritized order comprises ordering, in the redirection command, second RAT operating frequencies identified from a measurement object before second RAT operating frequencies identified from a system information block of the first RAT protocol stack.

In a thirteenth aspect, alone or in combination with one or more of the eleventh through twelfth aspects, transmitting the redirection command indicating the one or more second RAT operating frequencies in the prioritized order comprises ordering, in the redirection command, one or more second RAT operating frequencies identified from a measurement object based at least in part on at least one of an amount of time since each of the one or more second RAT operating frequencies have been measured by the UE, a measurement value associated with each of the one or more second RAT operating frequencies, or whether the UE detected each of the one or more second RAT operating frequencies when measuring the one or more second RAT operating frequencies.

In a fourteenth aspect, alone or in combination with one or more of the ninth through thirteenth aspects, process 800 includes initiating a first timer upon transmitting the redirection command, and refraining from performing another operation to release the communication connection with a redirection to the second RAT until after the first timer expires.

In a fifteenth aspect, alone or in combination with one or more of the ninth through fourteenth aspects, process 800 includes initiating a second timer upon transmitting the redirection command, and establishing, if the UE has not established a communication connection with the second RAT prior to an expiration of the second timer, another communication connection with the first RAT.

In a sixteenth aspect, alone or in combination with one or more of the sixth through fifteenth aspects, process 800 includes determining whether a voice over NR capability is supported by the UE and a serving cell associated with the communication connection with the first RAT.

In a seventeenth aspect, alone or in combination with the sixteenth aspect, process 800 includes performing an operation to release the communication connection with a redirection to the second RAT if at least one of the UE or the serving cell does not support the voice over NR capability.

In an eighteenth aspect, alone or in combination with the sixteenth aspect, process 800 includes refraining from performing an operation to release the communication connection with a redirection to the second RAT if both the UE and the serving cell support the voice over NR capability.

In a nineteenth aspect, alone or in combination with one or more of the sixteenth through eighteenth aspects, determining whether the voice over NR capability is supported by the UE and the serving cell associated with the communication connection with the first RAT comprises determining whether the serving cell associated with the communication connection with the first RAT supports the voice over NR capability based at least in part on at least one of a previous interaction with the serving cell, or an interaction of another UE with the serving cell.

In a twentieth aspect, alone or in combination with one or more of the sixteenth through nineteenth aspects, determining whether the voice over NR capability is supported by the UE and the serving cell associated with the communication connection with the first RAT comprises determining that the serving cell associated with the communication connection with the first RAT does not support the voice over NR capability based at least in part on at least one of receiving, from the serving cell, an indication to fallback to the second RAT in response to a request to establish a voice call, or receiving, from the serving cell, an indication that the voice over NR capability is not supported by the serving cell.

In a twenty-first aspect, alone or in combination with one or more of the sixteenth through twentieth aspects, determining whether the voice over NR capability is supported by the UE and the serving cell associated with the communication connection with the first RAT comprises determining whether the voice over NR capability is supported by the UE and the serving cell based at least in part on at least one of an indication included in the indication to deprioritize the first RAT, or a configuration of the UE.

In a twenty-second aspect, establishing the communication connection comprises establishing, in an idle communication mode or an inactive communication mode, a communication connection with the first RAT.

In a twenty-third aspect, alone or in combination with the through twenty-second aspect, performing the action to deprioritize the first RAT comprises at least one of modifying, in a first RAT protocol stack of the UE, one or more cell reselection criteria parameters associated with the first RAT, or modifying, in the first RAT protocol stack of the UE, one or more cell reselection criteria parameters associated with the second RAT.

In a twenty-fourth aspect, alone or in combination with the twenty-third aspect, a cell reselection criteria parameter includes at least one of a cell reselection priority parameter, a cell reselection receive signal level threshold parameter, or a cell reselection receive signal quality threshold parameter.

In a twenty-fifth aspect, alone or in combination with one or more of the twenty-second through twenty-fourth aspects, performing the action to deprioritize the first RAT comprises refraining from entering a sleep mode associated with the idle communication mode or the inactive communication mode, performing a continuous search for and measurement of second RAT operating frequencies, and suspending a search for and measurement of first RAT operating frequencies.

In a twenty-sixth aspect, alone or in combination with one or more of the twenty-second through twenty-fifth aspects, performing the action to deprioritize the first RAT comprises initiating a panic search timer, performing a panic search procedure to search for second RAT operating frequencies, and terminating the panic search procedure after an expiration of the panic search timer.

In a twenty-seventh aspect, establishing the communication connection comprises establishing, in a connected communication mode, a communication connection with the second RAT.

In a twenty-eighth aspect, alone or in combination with the twenty-seventh aspect, performing the action to deprioritize the first RAT comprises refraining from transmitting, to a serving cell associated with the communication connection, a measurement report associated with first RAT operating frequencies.

In a twenty-ninth aspect, alone or in combination with one or more of the twenty-seventh through twenty-eighth aspects, process 800 includes receiving, from a serving cell associated with the communication connection, a handover command indicating that the UE is to perform a handover procedure to a first RAT operating frequency, wherein performing the action to deprioritize the first RAT comprises reestablishing, based at least in part on the indication to deprioritize the first RAT, the communication connection with the second RAT.

In a thirtieth aspect, alone or in combination with one or more of the twenty-seventh through twenty-ninth aspects, process 800 includes receiving, from a serving cell associated with the communication connection, a release with redirection command indicating that the UE is to redirect to a first RAT operating frequency, wherein performing the action to deprioritize the first RAT comprises releasing the communication connection, and establishing, in an idle communication mode, another communication connection with the second RAT.

In a thirty-first aspect, establishing the communication connection comprises establishing, in an idle communication mode, a communication connection with the second RAT.

In a thirty-second aspect, alone or in combination with the thirty-first aspect, performing the action to deprioritize the first RAT comprises at least one of modifying, in a second RAT protocol stack of the UE, one or more cell reselection criteria parameters associated with the first RAT, or modifying, in the second RAT protocol stack of the UE, one or more cell reselection criteria parameters associated with the second RAT.

In a thirty-third aspect, alone or in combination with one or more of the first through thirty-second aspects, the indication to deprioritize the first RAT is based at least in part on detecting at least one of a WiFi voice call, that a temperature of the UE is above a temperature threshold, that a battery level of the UE is below a charge threshold, or that a communication connection with the first RAT is unstable.

In a thirty-fourth aspect, alone or in combination with one or more of the first through thirty-third aspects, the first RAT is an NR RAT and the second RAT is an LTE RAT.

In a thirty-fifth aspect, alone or in combination with one or more of the first through thirty-fourth aspects, the indication to deprioritize the first RAT includes an indication to deprioritize one or more cells.

In a thirty-sixth aspect, alone or in combination with one or more of the first through thirty-fifth aspects, performing the action comprises at least one of: refraining from selecting a cell included in the one or more cells unless no other cell is available; refraining from reselecting to a cell included in the one or more cells; initiating an RLF based at least in part on performing a handover with a cell included in the one or more cells; or initiating an RLF based at least in part on being connected to a cell included in the one or more cells.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a block diagram of an example apparatus 900 for wireless communication, in accordance with the present disclosure. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include one or more of an identification component 908 and/or a RAT deprioritization component 910, among other examples.

In some aspects, the apparatus 900 may be configured to perform one or more operations described herein in connection with FIGS. 4-7. Additionally, or alternatively, the apparatus 900 may be configured to perform one or more processes described herein, such as process 800 of FIG. 8, or a combination thereof. In some aspects, the apparatus 900 and/or one or more components shown in FIG. 9 may include one or more components of the UE described above in connection with FIG. 2. Additionally, or alternatively, one or more components shown in FIG. 9 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 906. In some aspects, the reception component 902 may include one or more antennas, a demodulator, a MIMO detector, a receive processor, a controller/processor, a memory, or a combination thereof, of the UE described above in connection with FIG. 2.

The transmission component 904 may transmit communications, such as reference signals, control information, data communications, or a combination thereof, to the apparatus 906. In some aspects, one or more other components of the apparatus 906 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modulator, a transmit MIMO processor, a transmit processor, a controller/processor, a memory, or a combination thereof, of the UE described above in connection with FIG. 2. In some aspects, the transmission component 904 may be co-located with the reception component 902 in a transceiver.

The reception component 902 and/or the transmission component 904 may establish, in a communication mode, a communication connection with a first RAT or a second RAT. The reception component 902 and/or the identification component 908 may receive or identify, by a modem of the UE, an indication to deprioritize the first RAT. The RAT deprioritization component 910 may perform, based at least in part on the indication to deprioritize the first RAT, an action to deprioritize the first RAT, wherein the action is based at least in part in the communication mode.

The transmission component 904 may transmit, from the modem to a first RAT protocol stack of the UE, an indication to deprioritize the first RAT. The transmission component 904 may transmit, from the modem to a second RAT protocol stack of the UE, an indication to deprioritize the first RAT.

The identification component 908 may identify one or more second RAT operating frequencies from a second RAT measurement object or a system information block of the first RAT protocol stack.

The RAT deprioritization component 910 may initiate a first timer upon transmitting the redirection command. The RAT deprioritization component 910 may refrain from performing another operation to release the communication connection with a redirection to the second RAT until after the first timer expires.

The RAT deprioritization component 910 may initiate a second timer upon transmitting the redirection command. The reception component 902 and/or the transmission component 904 may establish, if the UE has not established a communication connection with the second RAT prior to an expiration of the second timer, another communication connection with the first RAT.

The RAT deprioritization component 910 may determine whether a voice over NR capability is supported by the UE and a serving cell associated with the communication connection with the first RAT.

The RAT deprioritization component 910 may perform an operation to release the communication connection with a redirection to the second RAT if at least one of the UE or the serving cell does not support the voice over NR capability.

The RAT deprioritization component 910 may refrain from performing an operation to release the communication connection with a redirection to the second RAT if both the UE and the serving cell support the voice over NR capability.

The reception component 902 may receive, from a serving cell associated with the communication connection, a handover command indicating that the UE is to perform a handover procedure to a first RAT operating frequency. The RAT deprioritization component 910 may reestablish, based at least in part on the indication to deprioritize the first RAT, the communication connection with the second RAT.

The reception component 902 may receive, from a serving cell associated with the communication connection, a release with redirection command indicating that the UE is to redirect to a first RAT operating frequency. The RAT deprioritization component 910 may release the communication connection. The RAT deprioritization component 910 may establish, in an idle communication mode, another communication connection with the second RAT.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: establishing, in a communication mode, a communication connection with a first radio access technology (RAT) or a second RAT; receiving or identifying, by a modem of the UE, an indication to deprioritize the first RAT; and performing, based at least in part on the indication to deprioritize the first RAT, an action to deprioritize the first RAT, wherein the action is based at least in part in the communication mode.

Aspect 2: The method of Aspect 1, wherein establishing the communication connection comprises: establishing a first communication connection with the first RAT; and wherein performing the action to deprioritize the first RAT comprises: terminating the first communication connection with the first RAT; and establishing a second communication connection with the second RAT.

Aspect 3: The method of Aspect 1, wherein establishing the communication connection comprises: establishing a first communication connection with the second RAT; and wherein performing the action to deprioritize the first RAT comprises: maintaining the first communication connection with the second RAT; and refraining from establishing a second communication connection with the first RAT.

Aspect 4: The method of any of Aspects 1-3, further comprising: transmitting, by the modem of the UE and to a first RAT protocol stack of the UE, an indication to deprioritize the first RAT; and transmitting, by the modem of the UE and to a second RAT protocol stack of the UE, an indication to deprioritize the first RAT.

Aspect 5: The method of any of Aspects 1-4, wherein receiving or identifying the indication to deprioritize the first RAT comprises: receiving, by the modem and from an application programming interface (API), the indication to deprioritize the first RAT.

Aspect 6: The method of any of Aspects 1-4, wherein receiving or identifying the indication to deprioritize the first RAT comprises: identifying, by the modem, a trigger to deprioritize the first RAT.

Aspect 7: The method of any of Aspects 1-6, wherein establishing the communication connection comprises: establishing, in a connected communication mode, a communication connection with the first RAT.

Aspect 8: The method of Aspect 7, wherein performing the action to deprioritize the first RAT comprises: performing a local release of the communication connection with the first RAT.

Aspect 9: The method of any of Aspects 7-8, wherein performing the action to deprioritize the first RAT comprises: performing an operation to autonomously release the communication connection with a redirection to the second RAT.

Aspect 10: The method of any of Aspects 7-9, wherein performing the action to deprioritize the first RAT comprises: transmitting, from a first RAT protocol stack of the UE and to a second RAT protocol stack of the UE, a redirection command indicating one or more second RAT operating frequencies.

Aspect 11: The method of Aspect 10, further comprising: identifying the one or more second RAT operating frequencies from a second RAT measurement object or a system information block of the first RAT protocol stack.

Aspect 12: The method of any of Aspects 10-11, wherein transmitting the redirection command indicating the one or more second RAT operating frequencies comprises: transmitting, from the first RAT protocol stack of the UE and to the second RAT protocol stack of the UE, the redirection command indicating the one or more second RAT operating frequencies in a prioritized order.

Aspect 13: The method of Aspect 12, wherein transmitting the redirection command indicating the one or more second RAT operating frequencies in the prioritized order comprises: ordering, in the redirection command, second RAT operating frequencies identified from a measurement object before second RAT operating frequencies identified from a system information block of the first RAT protocol stack.

Aspect 14: The method of any of Aspects 12-13, wherein transmitting the redirection command indicating the one or more second RAT operating frequencies in the prioritized order comprises: ordering, in the redirection command, one or more second RAT operating frequencies identified from a measurement object based at least in part on at least one of: an amount of time since each of the one or more second RAT operating frequencies have been measured by the UE, a measurement value associated with each of the one or more second RAT operating frequencies, or whether the UE detected each of the one or more second RAT operating frequencies when measuring the one or more second RAT operating frequencies.

Aspect 15: The method of any of Aspects 10-14, further comprising: initiating a first timer upon transmitting the redirection command; and refraining from performing another operation to release the communication connection with a redirection to the second RAT until after the first timer expires.

Aspect 16: The method of any of Aspects 10-15, further comprising: initiating a second timer upon transmitting the redirection command; and establishing, if the UE has not established a communication connection with the second RAT prior to an expiration of the second timer, another communication connection with the first RAT.

Aspect 17: The method of any of Aspects 7-16, further comprising: determining whether a voice over NR capability is supported by the UE and a serving cell associated with the communication connection with the first RAT.

Aspect 18: The method of Aspect 17, further comprising: performing an operation to release the communication connection with a redirection to the second RAT if at least one of the UE or the serving cell does not support the voice over NR capability.

Aspect 19: The method of Aspect 17, further comprising: refraining from performing an operation to release the communication connection with a redirection to the second RAT if both the UE and the serving cell support the voice over NR capability.

Aspect 20: The method of any of Aspects 17-19, wherein determining whether the voice over NR capability is supported by the UE and the serving cell associated with the communication connection with the first RAT comprises: determining whether the serving cell associated with the communication connection with the first RAT supports the voice over NR capability based at least in part on at least one of: a previous interaction with the serving cell, or an interaction of another UE with the serving cell.

Aspect 21: The method of any of Aspects 17-20, wherein determining whether the voice over NR capability is supported by the UE and the serving cell associated with the communication connection with the first RAT comprises: determining that the serving cell associated with the communication connection with the first RAT does not support the voice over NR capability based at least in part on at least one of: receiving, from the serving cell, an indication to fallback to the second RAT in response to a request to establish a voice call, or receiving, from the serving cell, an indication that the voice over NR capability is not supported by the serving cell.

Aspect 22: The method of any of Aspects 17-21, wherein determining whether the voice over NR capability is supported by the UE and the serving cell associated with the communication connection with the first RAT comprises: determining whether the voice over NR capability is supported by the UE and the serving cell based at least in part on at least one of: an indication included in the indication to deprioritize the first RAT, or a configuration of the UE.

Aspect 23: The method of Aspect 1, wherein establishing the communication connection comprises: establishing, in an idle communication mode or an inactive communication mode, a communication connection with the first RAT.

Aspect 24: The method of Aspect 23, wherein performing the action to deprioritize the first RAT comprises at least one of: modifying, in a first RAT protocol stack of the UE, one or more cell reselection criteria parameters associated with the first RAT; or modifying, in the first RAT protocol stack of the UE, one or more cell reselection criteria parameters associated with the second RAT.

Aspect 25: The method of Aspect 24, wherein a cell reselection criteria parameter includes at least one of: a cell reselection priority parameter, a cell reselection receive signal level threshold parameter, or a cell reselection receive signal quality threshold parameter.

Aspect 26: The method of any of Aspects 23-25, wherein performing the action to deprioritize the first RAT comprises: refraining from entering a sleep mode associated with the idle communication mode or the inactive communication mode; performing a continuous search for and measurement of second RAT operating frequencies; and suspending a search for and measurement of first RAT operating frequencies.

Aspect 27: The method of any of Aspects 23-26, wherein performing the action to deprioritize the first RAT comprises: initiating a panic search timer; performing a panic search procedure to search for second RAT operating frequencies; and terminating the panic search procedure after an expiration of the panic search timer.

Aspect 28: The method of Aspect 1, wherein establishing the communication connection comprises: establishing, in a connected communication mode, a communication connection with the second RAT.

Aspect 29: The method of Aspect 28, wherein performing the action to deprioritize the first RAT comprises: refraining from transmitting, to a serving cell associated with the communication connection, a measurement report associated with first RAT operating frequencies.

Aspect 30: The method of any of Aspects 28-29, further comprising: receiving, from a serving cell associated with the communication connection, a handover command indicating that the UE is to perform a handover procedure to a first RAT operating frequency, wherein performing the action to deprioritize the first RAT comprises: reestablishing, based at least in part on the indication to deprioritize the first RAT, the communication connection with the second RAT.

Aspect 31: The method of any of Aspects 28-30, further comprising: receiving, from a serving cell associated with the communication connection, a release with redirection command indicating that the UE is to redirect to a first RAT operating frequency, wherein performing the action to deprioritize the first RAT comprises: releasing the communication connection; and establishing, in an idle communication mode, another communication connection with the second RAT.

Aspect 32: The method of Aspect 1, wherein establishing the communication connection comprises: establishing, in an idle communication mode, a communication connection with the second RAT.

Aspect 33: The method of Aspect 32, wherein performing the action to deprioritize the first RAT comprises at least one of: modifying, in a second RAT protocol stack of the UE, one or more cell reselection criteria parameters associated with the first RAT; or modifying, in the second RAT protocol stack of the UE, one or more cell reselection criteria parameters associated with the second RAT.

Aspect 34: The method of any of Aspects 1-33, wherein the indication to deprioritize the first RAT is based at least in part on detecting at least one of: a WiFi voice call, that a temperature of the UE is above a temperature threshold, that a battery level of the UE is below a charge threshold, or that a communication connection with the first RAT is unstable.

Aspect 35: The method of any of Aspects 1-34, wherein the first RAT is a New Radio (NR) RAT and the second RAT is a Long Term Evolution (LTE) RAT.

Aspect 36: The method of any of Aspects 1-35, wherein the indication to deprioritize the first RAT includes an indication to deprioritize one or more cells.

Aspect 37: The method of Aspect 36, wherein the indication to deprioritize the one or more cells is based at least in part on a performance of the one or more cells.

Aspect 38: The method of any of Aspects 36-37, wherein performing the action comprises at least one of: refraining from selecting a cell included in the one or more cells unless no other cell is available; refraining from reselecting to a cell included in the one or more cells; initiating a radio link failure (RLF) based at least in part on performing a handover with a cell included in the one or more cells; or initiating an RLF based at least in part on being connected to a cell included in the one or more cells.

Aspect 39: An apparatus for wireless communication at a device, comprising a processor; memory coupled with the processor; and instructions stored in the memory and executable by the processor to cause the apparatus to perform the method of one or more Aspects of Aspects 1-38.

Aspect 40: A device for wireless communication, comprising a memory and one or more processors coupled to the memory, the memory and the one or more processors configured to perform the method of one or more Aspects of Aspects 1-38.

Aspect 41: An apparatus for wireless communication, comprising at least one means for performing the method of one or more Aspects of Aspects 1-38.

Aspect 42: A non-transitory computer-readable medium storing code for wireless communication, the code comprising instructions executable by a processor to perform the method of one or more Aspects of Aspects 1-38.

Aspect 43: A non-transitory computer-readable medium storing a set of instructions for wireless communication, the set of instructions comprising one or more instructions that, when executed by one or more processors of a device, cause the device to perform the method of one or more Aspects of Aspects 1-38.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
establishing, in a communication mode, a communication connection using a first radio access technology (RAT) or a second RAT;
receiving or identifying, by a modem of the UE, an indication to deprioritize the first RAT; and
performing, based at least in part on the indication to deprioritize the first RAT, an action to deprioritize the first RAT, wherein the action is based at least in part in the communication mode.

2. The method of claim 1, wherein establishing the communication connection comprises:
establishing a first communication connection with the first RAT; and
wherein performing the action to deprioritize the first RAT comprises:
terminating the first communication connection with the first RAT; and
establishing a second communication connection with the second RAT.

3. The method of claim 1, wherein establishing the communication connection comprises:
establishing a first communication connection with the second RAT; and
wherein performing the action to deprioritize the first RAT comprises:
maintaining the first communication connection with the second RAT; and
refraining from establishing a second communication connection with the first RAT.

4. The method of claim 1, further comprising:
transmitting, by the modem of the UE and to a first RAT protocol stack of the UE, an indication to deprioritize the first RAT; and
transmitting, by the modem of the UE and to a second RAT protocol stack of the UE, an indication to deprioritize the first RAT.

5. The method of claim 1, wherein the communication connection is with the first RAT, wherein the communication mode is a connected communication mode, and wherein performing the action to deprioritize the first RAT comprises:
performing an operation to autonomously release the communication connection with a redirection to the second RAT.

6. The method of claim 1, wherein the communication connection is with the first RAT, wherein the communication mode is a connected communication mode, and wherein performing the action to deprioritize the first RAT comprises:
transmitting, from a first RAT protocol stack of the UE and to a second RAT protocol stack of the UE, a redirection command indicating one or more second RAT operating frequencies.

7. The method of claim 6, wherein transmitting the redirection command indicating the one or more second RAT operating frequencies comprises:
transmitting, from the first RAT protocol stack of the UE and to the second RAT protocol stack of the UE, the redirection command indicating the one or more second RAT operating frequencies in a prioritized order.

8. The method of claim 6, further comprising:
initiating a first timer upon transmitting the redirection command; and
refraining from performing another operation to release the communication connection with a redirection to the second RAT until after the first timer expires.

9. The method of claim 6, further comprising:
initiating a second timer upon transmitting the redirection command; and
establishing, if the UE has not established a communication connection with the second RAT prior to an expiration of the second timer, another communication connection with the first RAT.

10. The method of claim 1, wherein the communication connection is with the first RAT, wherein the communication mode is a connected communication mode, and the method further comprising:
performing an operation to release the communication connection with a redirection to the second RAT if at least one of the UE or a serving cell does not support a voice over NR capability; or
refraining from performing an operation to release the communication connection with a redirection to the second RAT if both the UE and the serving cell support the voice over NR capability.

11. The method of claim 1, wherein the communication connection is with the second RAT, wherein the communication mode is a connected communication mode, and wherein performing the action to deprioritize the first RAT comprises:
refraining from transmitting, to a serving cell associated with the communication connection, a measurement report associated with first RAT operating frequencies.

12. The method of claim 1, wherein the communication connection is with the second RAT, wherein the communication mode is a connected communication mode, the method further comprising:
receiving, from a serving cell associated with the communication connection, a handover command indicating that the UE is to perform a handover procedure to a first RAT operating frequency,
wherein performing the action to deprioritize the first RAT comprises:
reestablishing, based at least in part on the indication to deprioritize the first RAT, the communication connection with the second RAT.

13. The method of claim 1, wherein the indication to deprioritize the first RAT includes an indication to deprioritize one or more cells.

14. The method of claim 13, wherein the indication to deprioritize the one or more cells is based at least in part on a performance of the one or more cells.

15. The method of claim 13, wherein performing the action comprises at least one of:
refraining from selecting a cell included in the one or more cells unless no other cell is available;
refraining from reselecting to a cell included in the one or more cells;
initiating a radio link failure (RLF) based at least in part on performing a handover with a cell included in the one or more cells; or
initiating an RLF based at least in part on being connected to a cell included in the one or more cells.

16. A user equipment (UE) for wireless communication, comprising:
a memory; and
one or more processors, coupled to the memory, configured to:
establish, in a communication mode, a communication connection using a first radio access technology (RAT) or a second RAT;
receive or identify, by a modem of the UE, an indication to deprioritize the first RAT; and
perform, based at least in part on the indication to deprioritize the first RAT, an action to deprioritize the first RAT, wherein the action is based at least in part in the communication mode.

17. The UE of claim 16, wherein the one or more processors, to establish the communication connection, are configured to:
establish a first communication connection with the first RAT; and
wherein the one or more processors, to perform the action to deprioritize the first RAT, are configured to:
terminate the first communication connection with the first RAT; and
establish a second communication connection with the second RAT.

18. The UE of claim 16, wherein the one or more processors, to establish the communication connection, are configured to:
establish a first communication connection with the second RAT; and
wherein the one or more processors, to perform the action to deprioritize the first RAT, are configured to:
maintain the first communication connection with the second RAT; and
refrain from establishing a second communication connection with the first RAT.

19. The modem of claim 16, wherein the one or more processors, to receive or identifying the indication to deprioritize the first RAT, are configured to:
receive, from an application programming interface (API), the indication to deprioritize the first RAT.

20. The UE of claim 16, wherein the communication connection is with the first RAT, wherein the communication mode is a connected communication mode, and wherein the one or more processors, to perform the action to deprioritize the first RAT, are configured to:
perform an operation to autonomously release the communication connection with a redirection to the second RAT.

21. The UE of claim 16, wherein the communication connection is with the first RAT, wherein the communication mode is a connected communication mode, and wherein the one or more processors, to perform the action to deprioritize the first RAT, are configured to:
transmit, from a first RAT protocol stack of the UE and to a second RAT protocol stack of the UE, a redirection command indicating one or more second RAT operating frequencies.

22. The UE of claim 21, wherein the one or more processors, to transmit the redirection command indicating the one or more second RAT operating frequencies, are configured to:
transmit, from the first RAT protocol stack of the UE and to the second RAT protocol stack of the UE, the redirection command indicating the one or more second RAT operating frequencies in a prioritized order.

23. The UE of claim 16, wherein the communication connection is with the first RAT, wherein the communication mode is a connected communication mode, and wherein the one or more processors are further configured to:
perform an operation to release the communication connection with a redirection to the second RAT if at least one of the UE or a serving cell does not support a voice over NR capability; or
refrain from performing an operation to release the communication connection with a redirection to the second RAT if both the UE and the serving cell support the voice over NR capability.

24. The UE of claim 16, wherein the communication connection is with the first RAT, wherein the communication mode is an idle communication mode or an inactive communication mode, and wherein the one or more processors, to perform the action to deprioritize the first RAT, are configured to at least one of:
modify, in a first RAT protocol stack of the UE, one or more cell reselection criteria parameters associated with the first RAT; or
modify, in the first RAT protocol stack of the UE, one or more cell reselection criteria parameters associated with the second RAT.

25. The UE of claim 16, wherein the communication connection is with the second RAT, wherein the communication mode is a connected communication mode, and wherein the one or more processors, to perform the action to deprioritize the first RAT, are configured to:
refrain from transmitting, to a serving cell associated with the communication connection, a measurement report associated with first RAT operating frequencies.

26. The UE of claim 16, wherein the communication connection is with the second RAT, wherein the communication mode is a connected communication mode, and wherein the one or more processors are further configured to:
receive, from a serving cell associated with the communication connection, a handover command indicating that the UE is to perform a handover procedure to a first RAT operating frequency,
wherein the one or more processors, to perform the action to deprioritize the first RAT, are configured to:
reestablish, based at least in part on the indication to deprioritize the first RAT, the communication connection with the second RAT.

27. The UE of claim 16, wherein the communication connection is with the second RAT, wherein the communication mode is a connected communication mode, and wherein the one or more processors are further configured to:
receive, from a serving cell associated with the communication connection, a release with redirection command indicating that the UE is to redirect to a first RAT operating frequency,
wherein the one or more processors, to perform the action to deprioritize the first RAT, are configured to:
release the communication connection; and
establish, in an idle communication mode, another communication connection with the second RAT.

28. The UE of claim 16, wherein the communication connection is with the second RAT, wherein the communication mode is an idle communication mode, and wherein the one or more processors, to perform the action to deprioritize the first RAT, are configured to at least one of:
modify, in a second RAT protocol stack of the UE, one or more cell reselection criteria parameters associated with the first RAT; or
modify, in the second RAT protocol stack of the UE, one or more cell reselection criteria parameters associated with the second RAT.

29. A non-transitory computer-readable medium storing a set of instructions for wireless communication, the set of instructions comprising:
one or more instructions that, when executed by one or more processors of a user equipment (UE), cause the UE to:
establish, in a communication mode, a communication connection using a first radio access technology (RAT) or a second RAT;
receive or identifying, by a modem of the UE, an indication to deprioritize the first RAT; and
perform, based at least in part on the indication to deprioritize the first RAT, an action to deprioritize the first RAT, wherein the action is based at least in part in the communication mode.

30. An apparatus for wireless communication, comprising:
means for establishing, in a communication mode, a communication connection using a first radio access technology (RAT) or a second RAT;
means for receiving or identifying, by a modem of the apparatus, an indication to deprioritize the first RAT; and
means for performing, based at least in part on the indication to deprioritize the first RAT, an action to deprioritize the first RAT, wherein the action is based at least in part in the communication mode.
